(19) United States
(12) Patent Application Publication
(10) Pub. No.: US 2010/0211966 A1
(43) Pub. Date: Aug. 19, 2010

(54) VIEW QUALITY JUDGING DEVICE, VIEW QUALITY JUDGING METHOD, VIEW QUALITY JUDGING PROGRAM, AND RECORDING MEDIUM

(75) Inventors: Wenli Zhang, Kanagawa (JP); Toru Nakada, Kyoto (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/377,308

(22) PCT Filed: Feb. 18, 2008
(86) PCT No.: PCT/JP2008/000249

§ 371 Date: Feb. 12, 2009

(30) Foreign Application Priority Data
Feb. 20, 2007 (JP) 2007-040072

(51) Int. Cl. H04H 60/33; H04N 7/16; H04N 7/173

(52) U.S. Cl. 725/10; 725/14

(57) ABSTRACT

Provided is a view quality judging device capable of accurately judging the view quality without posing a load on a viewer. The view quality judging device is used in view quality data generation device (100), which includes an expected feeling value information generation unit (300) for acquiring expected feeling value information indicating feeling expected to be generated in a viewer who vies a content; a feeling information generation unit (200) for acquiring feeling information indicating the feeling generated in the viewer upon viewing the content; and a view quality data generation unit (400) for judging the view quality of the content by comparing the expected feeling value information to the feeling information.

### TECHNICAL FIELD

The present invention relates to a technology for judging audience quality indicating with what degree of interest a viewer views content, and more particularly, to a audience quality judging apparatus, audience quality judging method, and audience quality judging program for judging audience quality based on information detected from a viewer, and a recording medium that stores this program.

### BACKGROUND ART

Audience quality is information that indicates with what degree of interest a viewer views content such as a broadcast program, and has attracted attention as a content evaluation index. Viewer surveys, for example, have traditionally been used as a method of judging the audience quality of content, but a problem with such viewer surveys is that they impose a burden on the viewers.

Thus, a technology whereby audience quality is judged automatically based on information detected from a viewer has been described in Patent Document 1, for example. With the technology described in Patent Document 1, biological information such as a viewer's line of sight direction, pupil diameter, operations with respect to content, heart rate, and so forth, is detected from the viewer, and audience quality is judged based on the detected information. This enables audience quality to be judged while reducing the burden on the viewer.

### Patent Document 1: Japanese Patent Application Laid-Open No. 2005-142975

### DISCLOSURE OF INVENTION

### Problems to be Solved by the Invention

However, with the technology described in Patent Document 1, it is not possible to determine the extent to which information detected from a viewer is influenced by the viewer's actual degree of interest in content. Therefore, a problem with the technology described in Patent Document 1 is that audience quality cannot be judged accurately.

For example, if a viewer is directing his line of sight toward content while talking with another person on the telephone, the viewer may be judged erroneously to be viewing the content with interest although not actually viewing it with much interest. Also, if, for example, a viewer is viewing content without much interest while his heart rate is high immediately after taking some exercise, the viewer may be judged erroneously to be viewing the content with interest. In order to improve the accuracy of audience quality judgment with the technology described in Patent Document 1, it is necessary to impose restrictions on a viewer, such as prohibiting phone calls while viewing, to minimize the influence of factors other than the degree of interest in content, which imposes a burden on a viewer.

It is an object of the present invention to provide a audience quality judging apparatus, audience quality judging method, and audience quality judging program that enable audience quality to be judged accurately without imposing any particular burden on a viewer, and a recording medium that stores this program.

### Means for Solving the Problems

A audience quality judging apparatus of the present invention employs a configuration having: an expected emotion value information acquisition section that acquires expected emotion value information indicating an emotion expected to occur in a viewer who views content; an emotion information acquisition section that acquires emotion information indicating an emotion that occurs in a viewer when viewing the content; and a audience quality judgment section that judges the audience quality of the content by comparing the emotion information with the expected emotion value information.

A audience quality judging method of the present invention has: an information acquiring step of acquiring expected emotion value information indicating an emotion expected to occur in a viewer who views content and emotion information indicating an emotion that occurs in a viewer when viewing the content; an information comparing step of comparing the emotion information with the expected emotion value information; and a audience quality judging step of judging audience quality of the content from the result of comparing the emotion information with the expected emotion value information.

### Advantageous Effect of the Invention

The present invention compares emotion information detected from a viewer with expected emotion value information indicating an emotion expected to occur in a viewer who views content. By this means, it is possible to distinguish between emotion information that is influenced by an actual degree of interest in content and emotion information that is not influenced by an actual degree of interest in content, and audience quality can be judged accurately. Also, since it is not necessary to impose restrictions on a viewer in order to suppress the influence of factors other than the degree of interest in content, above-described audience quality judgment can be implemented without imposing any particular burden on a viewer.

### BRIEF DESCRIPTION OF DRAWINGS

FIG. 1 is a block diagram showing the configuration of a audience quality data generation apparatus according to Embodiment 1 of the present invention;

FIG. 2 is an explanatory drawing showing an example of a two-dimensional emotion model used in Embodiment 1;

FIG. 3A is an explanatory drawing showing an example of the configuration of a BGM conversion table in Embodiment 1;

FIG. 3B is an explanatory drawing showing an example of the configuration of a sound effect conversion table in Embodiment 1;

FIG. 3C is an explanatory drawing showing an example of the configuration of a video shot conversion table in Embodiment 1;

FIG. 3D is an explanatory drawing showing an example of the configuration of a camerawork conversion table in Embodiment 1;

FIG. 4 is an explanatory drawing showing an example of a reference point type information management table in Embodiment 1;

FIG. 5 is a flowchart showing an example of the overall flow of audience quality data generation processing by a audience quality data generation apparatus in Embodiment 1;

FIG. 6 is an explanatory drawing showing an example of the configuration of emotion information output from an emotion information acquisition section in Embodiment 1;

FIG. 7 is an explanatory drawing showing an example of the configuration of video operation/attribute information output from a video operation/attribute information acquisition section in Embodiment 1;

FIG. 8 is a flowchart showing an example of the flow of expected emotion value information calculation processing by a reference point expected emotion value calculation section in Embodiment 1;

FIG. 9 is an explanatory drawing showing an example of reference point expected emotion value information output by a reference point expected emotion value calculation section in Embodiment 1;

FIG. 10 is a flowchart showing an example of the flow of time matching judgment processing by a time matching judgment section in Embodiment 1;

FIG. 11 is an explanatory drawing showing the presence of a plurality of reference points in one unit time in Embodiment 1;

FIG. 12 is a flowchart showing an example of the flow of emotion matching judgment processing by an emotion matching judgment section in Embodiment 1;

FIG. 13 is an explanatory drawing showing an example of a case in which there is time matching but there is no emotion matching in Embodiment 1;

FIG. 14 is an explanatory drawing showing an example of a case in which there is emotion matching but there is no time matching in Embodiment 1;

FIG. 15 is a flowchart showing an example of the flow of integral judgment processing by an integral judgment section in Embodiment 1;

FIG. 16 is a flowchart showing an example of the flow of judgment processing (1) by an integral judgment section in Embodiment 1;

FIG. 17 is a flowchart showing an example of the flow of judgment processing (3) by an integral judgment section in Embodiment 1;

FIG. 18 is an explanatory drawing showing how audience quality information is set by means of judgment processing (3) in Embodiment 1;

FIG. 19 is a flowchart showing an example of the flow of judgment processing (2) in Embodiment 1;

FIG. 20 is a flowchart showing an example of the flow of judgment processing (4) in Embodiment 1;

FIG. 21 is an explanatory drawing showing how audience quality information is set by means of judgment processing (4) in Embodiment 1;

FIG. 22 is an explanatory drawing showing an example of audience quality data information generated by an integral judgment section in Embodiment 1;

FIG. 23 is a block diagram showing the configuration of a audience quality data generation apparatus according to Embodiment 2 of the present invention;

FIG. 24 is an explanatory drawing showing an example of the configuration of a judgment table used in integral judgment processing using a line of sight;

FIG. 25 is a flowchart showing an example of the flow of judgment processing (5) in Embodiment 2; and

FIG. 26 is a flowchart showing an example of the flow of judgment processing (6) in Embodiment 2.

### BEST MODE FOR CARRYING OUT THE INVENTION

Embodiments of the present invention will now be described in detail with reference to the accompanying drawings.

### Embodiment 1

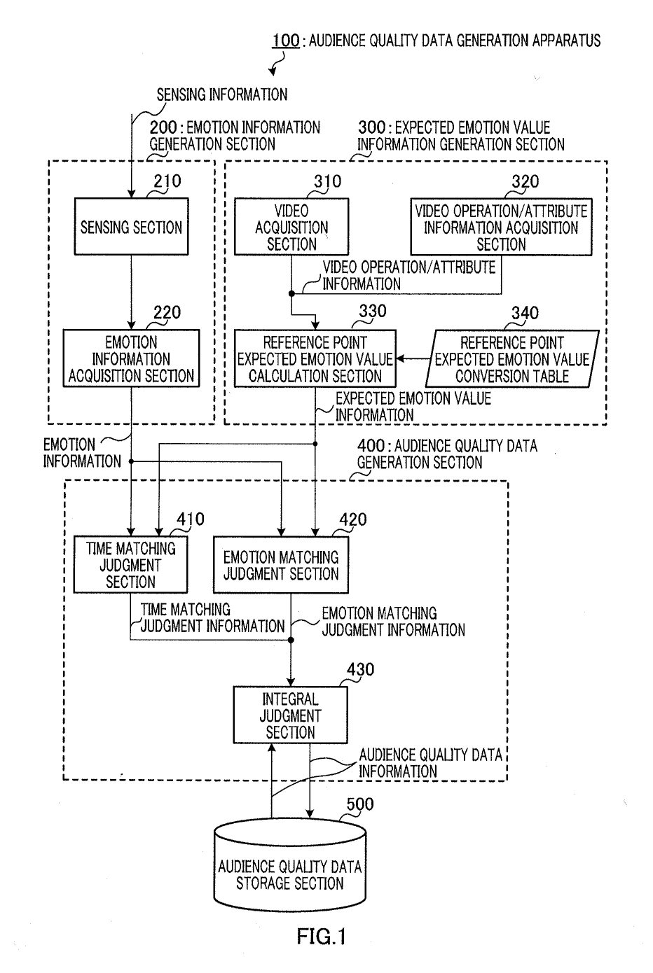

FIG. 1 is a block diagram showing the configuration of a audience quality data generation apparatus including a audience quality information judging apparatus according to the present invention. A case is described below in which an object of audience quality information judgment is video content with sound, such as a movie or drama.

In FIG. 1, audience quality data generation apparatus 100 has emotion information generation section 200, expected emotion value information generation section 300, audience quality data generation section 400, and audience quality data storage section 500.

Emotion information generation section 200 generates emotion information indicating an emotion that occurs in a viewer who is an object of audience quality judgment from biological information detected from the viewer. Here, “emotions” are assumed to denote not only the emotions of delight, anger, sorrow, and pleasure, but also mental states in general, including feelings such as relaxation. Also, emotion occurrence is assumed to include a transition from a particular mental state to a different mental state. Emotion information generation section 200 has sensing section 210 and emotion information acquisition section 220.

Sensing section 210 is connected to a detecting apparatus such as a sensor or digital camera (not shown), and detects (senses) a viewer's biological information. A viewer's biological information includes, for example, a viewer's heart rate, pulse, temperature, facial myoelectrical changes, voice, and so forth.

Emotion information acquisition section 220 generates emotion information including a measured emotion value and emotion occurrence time from viewer's biological information obtained by sensing section 210. Here, a measured emotion value is a value indicating an emotion that occurs in a viewer, and an emotion occurrence time is a time at which a respective emotion occurs.

Expected emotion value information generation section 300 generates expected emotion value information indicating an emotion expected to occur in a viewer when viewing video content from video content editing contents. Expected emotion value information generation section 300 has video acquisition section 310, video operation/attribute information acquisition section 320, reference point expected emotion value calculation section 330, and reference point expected emotion value conversion table 340.

Video acquisition section 310 acquires video content viewed by a viewer. Specifically, video acquisition section 310 acquires video content data from terrestrial broadcast or satellite broadcast receive data, a storage medium such as a DVD or hard disk, or a video distribution server on the Internet, for example.

Video operation/attribute information acquisition section 320 acquires video operation/attribute information including video content program attribute information or program operation information. Specifically, video operation/attribute information acquisition section 320 acquires video operation information from an operation history of a remote controller that operates video content playback, for example. Also, video operation/attribute information acquisition section 320 acquires video content attribute information from information added to played-back video content or an information server on the video content creation side.

Reference point expected emotion value calculation section 330 detects a reference point from video content. Also, reference point expected emotion value calculation section 330 calculates an expected emotion value corresponding to a detected reference point using reference point expected emotion value conversion table 340, and generates expected emotion value information. Here, a reference point is a place or interval in video content where there is video editing that has psychological or emotional influence on a viewer. An expected emotion value is a parameter indicating an emotion expected to occur in a viewer at each reference point based on the contents of the above video editing when the viewer views video content. Expected emotion value information is information including an expected emotion value and time of each reference point.

In reference point expected emotion value conversion table 340 there are entered in advance contents and expected emotion values in associated fashion for BGM (BackGround Music), sound effects, video shots, and camerawork contents.

Audience quality data generation section 400 compares emotion information with expected emotion value information, judges with what degree of interest a viewer viewed the content, and generates audience quality data information indicating the judgment result. Audience quality data generation section 400 has time matching judgment section 410, emotion matching judgment section 420, and integral judgment section 430.

Time matching judgment section 410 judges whether or not there is time matching, and generates time matching judgment information indicating the judgment result. Here, time matching means that timings at which an emotion occurs are synchronous for emotion information and expected emotion value information.

Emotion matching judgment section 420 judges whether or not there is emotion matching, and generates emotion matching judgment information indicating the judgment result. Here, emotion matching means that emotions are similar for emotion information and expected emotion value information.

Integral judgment section 430 integrates time matching judgment information and emotion matching judgment information, judges with what degree of interest a viewer is viewing video content, and generates audience quality data information indicating the judgment result.

Audience quality data storage section 500 stores generated audience quality data information.

Audience quality data generation apparatus 100 can be implemented, for example, by means of a CPU (Central Processing Unit), a storage medium such as ROM (Read Only Memory) that stores a control program, working memory such as RAM (Random Access Memory), and so forth. In this case, the functions of the above sections are implemented by execution of the control program by the CPU.

Before describing the operation of audience quality data generation apparatus 100, descriptions will first be given of an emotion model used for definition of emotions in audience quality data generation apparatus 100, and the contents of reference point expected emotion value conversion table 340.

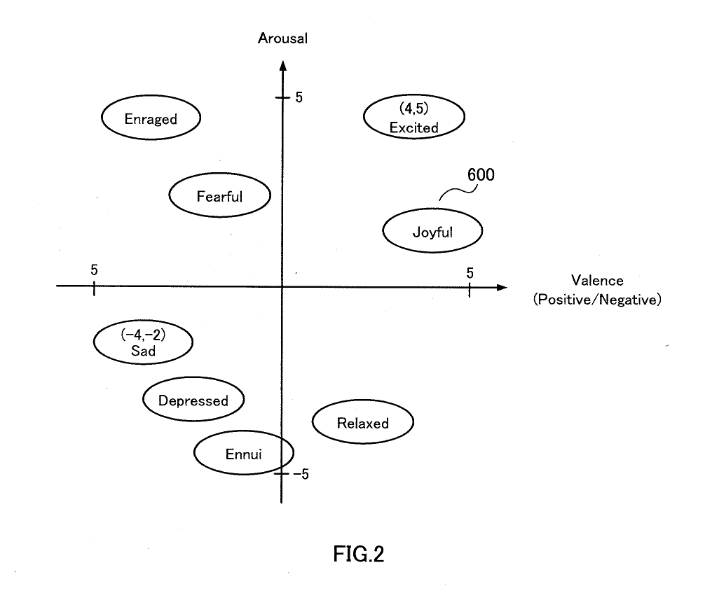

FIG. 2 is an explanatory drawing showing an example of a two-dimensional emotion model used in audience quality data generation apparatus 100. Two-dimensional emotion model 600 shown in FIG. 2 is called a LANG's emotion model, and comprises two axes: a horizontal axis indicating valence, which is a degree of pleasantness or unpleasantness, and a vertical access indicating arousal, which is a degree of excitement/tension or relaxation. In the two-dimensional space of two-dimensional emotion model 600, regions are defined by emotion type, such as “Excited”, “Relaxed”, “Sad”, and so forth, according to the relationship between the horizontal and vertical axes. Using two-dimensional emotion model 600, an emotion can easily be represented by a combination of a horizontal axis value and vertical axis value. The above-described expected emotion values and measured emotion values are coordinate values in this two-dimensional emotion model 600, indirectly representing an emotion.

Here, for example, coordinate values (4,5) denote a position in a region of the emotion type “Excited”. Therefore; an expected emotion value and measured emotion value comprising coordinate values (4,5) indicate the emotion “Excited”. Also, coordinate values (−4,−2) denote a position in a region of the emotion type “Sad”. Therefore, an expected emotion value and measured emotion value comprising coordinate values (−4,−2) indicate the emotion type “Sad”. When the distance between an expected emotion value and measured emotion value in two-dimensional emotion model 600 is short, the emotions indicated by each can be said to be similar.

A space of more than two dimensions and a model other than a LANG's emotion model maybe used as an emotion model. For example, a three-dimensional emotion model (pleasantness/unpleasantness, excitement/calmness, tension/relaxation) and six-dimensional emotion model (anger, fear, sadness, delight, dislike, surprise) are used. Using such an emotion model with more dimensions enables emotion types to be represented more precisely.

Next, reference point expected emotion value conversion table 340 will be described. Reference point expected emotion value conversion table 340 includes a plurality of conversion tables and a reference point type information management table for managing this plurality of conversion tables. A plurality of conversion tables are provided for each video content video editing type.

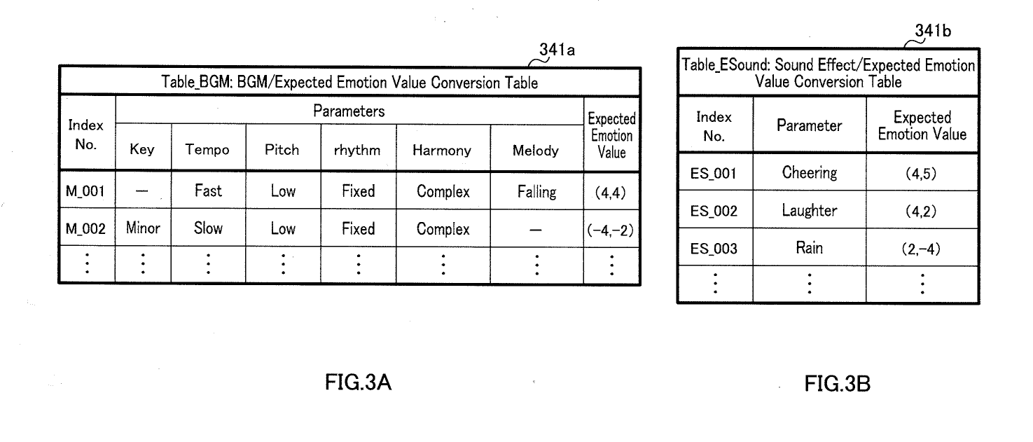

FIG. 3A through FIG. 3D are explanatory drawings showing examples of conversion table configurations.

BGM conversion table 341a shown in FIG. 3A associates an expected emotion value with BGM contents included in video content, and is given the table name “Table_BGM”. BGM contents are represented by a combination of key, tempo, pitch, rhythm, harmony, and melody parameters, and an expected emotion value is associated with each combination.

Sound effect conversion table 341b shown in FIG. 3B associates an expected emotion value with a parameter indicating sound effect contents included in video content, and is given the table name “Table_ESound”.

Video shot conversion table 341c shown in FIG. 3C associates a parameter indicating video shot contents included in video content with an expected emotion value, and is given the table name “Table_Shot”.

Camerawork conversion table 341d shown in FIG. 3D associates an expected emotion value with a parameter indicating camerawork contents included in video content, and is given the table name “Table_Camerawork”.

For example, in sound effect conversion table 341b, expected emotion value “(4,5)” is associated with sound effect contents “cheering”. Also, this expected emotion value “(4,5)” indicates emotion type “Excited” as described above. This association means that, in a state in which, when video content is viewed, it is viewed with interest, a viewer normally feels excited at a place where cheering is inserted. Also, in BGM conversion table 341a, expected emotion value “(−4,−2)” is associated with BGM contents “Key: minor, Tempo: slow, Pitch: low, Rhythm: fixed, Harmony: complex”. Also, this expected emotion value “(−4,−2)” indicates emotion type “Sad” as described above. This association means that, in a state in which, when video content is viewed, it is viewed with interest, a viewer normally feels sad at a place where BGM having the above contents is inserted.

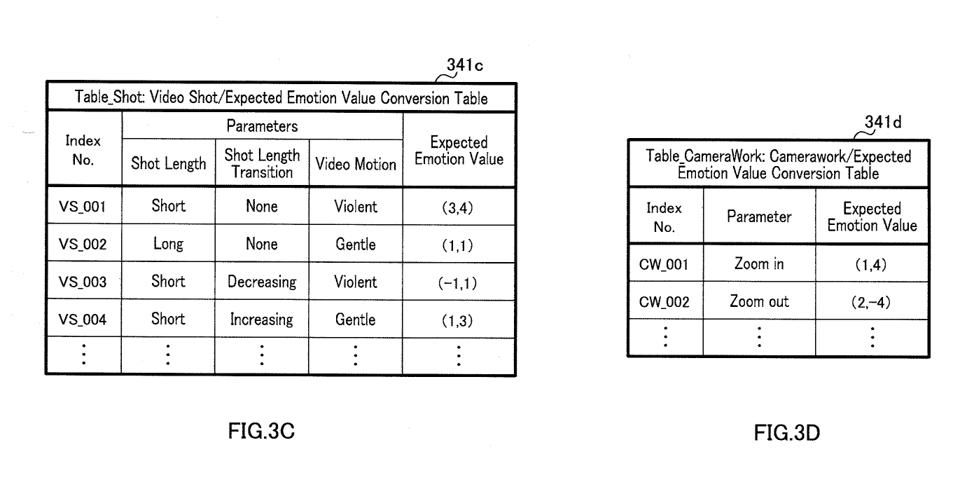

FIG. 4 is an explanatory drawing showing an example of a reference point type information management table. Reference point type information management table 342 shown in FIG. 4 associates the table names of conversion tables 341 shown in FIG. 3A through FIG. 3D—with a table type number (No.) assigned to each—with reference point type information indicating the type of a reference point acquired from video content. This association indicates which conversion table 341 should be referenced for which reference point type.

For example, table name “Table_BGM” is associated with reference point type information “BGM”. This association specifies that BGM conversion table 341a having table name “Table_BGM” shown in FIG. 3A is to be referenced when the type of an acquired reference point is “BGM”.

The operation of audience quality data generation apparatus 100 having the above configuration will now be described.

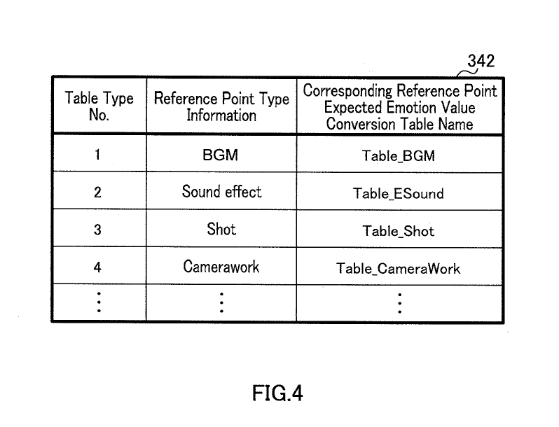

FIG. 5 is a flowchart showing an example of the overall flow of audience quality data generation processing by audience quality data generation apparatus 100. First, setting and so forth of a sensor or digital camera for detecting necessary biological information from a viewer is performed, and when this setting is completed, a user operation or the like is received, and audience quality data generation apparatus 100 audience quality data generation processing is started.

First, in step S1000, sensing section 210 senses biological information of a viewer when viewing video content, and outputs the acquired biological information to emotion information acquisition section 220. Biological information includes, for example, brain waves, electrical skin resistance, skin conductance, skin temperature, electrocardiogram frequency, heart rate, pulse, temperature, electromyography, facial image, voice, and so forth.

Next, in step S1100, emotion information acquisition section 220 analyzes biological information at predetermined time intervals of, for example, one second, generates emotion information indicating the viewer's emotion when viewing video content, and outputs this to audience quality data generation section 400. It is known that human physiological signals change according to changes in human emotions. Emotion information acquisition section 220 acquires a measured emotion value from the biological information using this relationship between a change of emotion and a change of a physiological signal.

For example, it is known that the more relaxed a person is, the greater is the alpha (α) wave component proportion in brain waves. It is also known that electrical skin resistance increases due to surprise, fear, or anxiety, skin temperature and electrocardiogram frequency increase in the event of an emotion of great delight, heart rate and pulse slow down when a person is psychologically and mentally calm, and so forth. In addition, it is known that types of expression and voice, such as crying, laughing, or becoming angry, change according to emotions of delight, anger, sorrow, pleasure, and so on. And it is further known that a person tends to speak quietly when depressed and to speak loudly when angry or happy.

Therefore, it is possible to acquire biological information through detection of electrical skin resistance, skin temperature, heart rate, pulse, and voice level, analysis of the alpha wave component proportion in brain waves, expression recognition based on facial myoelectrical changes or images, voice recognition, and so forth, and to analyze an emotion of that person from the biological information.

Specifically, for example, emotion information acquisition section 220 stores in advance a conversion table or conversion expression for converting values of the above biological information to coordinate values of two-dimensional emotion model 600 shown in FIG. 2. Then emotion information acquisition section 220 maps biological information input from sensing section 210 onto the two-dimensional space of two-dimensional emotion model 600 using the conversion table or conversion expression, and acquires the relevant coordinate values as a measured emotion value.

For example, a skin conductance signal increases according to arousal, and an electromyography (EMG) signal changes according to valence. Therefore, by measuring skin conductance in advance, associating the measurements with a degree of liking for content viewed by a viewer, it is possible to perform mapping of biological information onto the two-dimensional space of two-dimensional emotion model 600 by associating a skin conductance value with the vertical axis indicating arousal and associating an electromyography value with the horizontal axis indicating valence. A measured emotion value can easily be acquired by preparing these associations in advance and detecting a skin conductance signal and electromyography signal. An actual method of mapping biological information onto an emotion model space is described in, for example, “Emotion Recognition from Electromyography and Skin Conductance” (Arturo Nakasone, Helmut Prendinger, Mitsuru Ishizuka, The Fifth International Workshop on Biosignal Interpretation, BSI-05, Tokyo, Japan, 2005, pp. 219-222), and therefore a description thereof is omitted here.

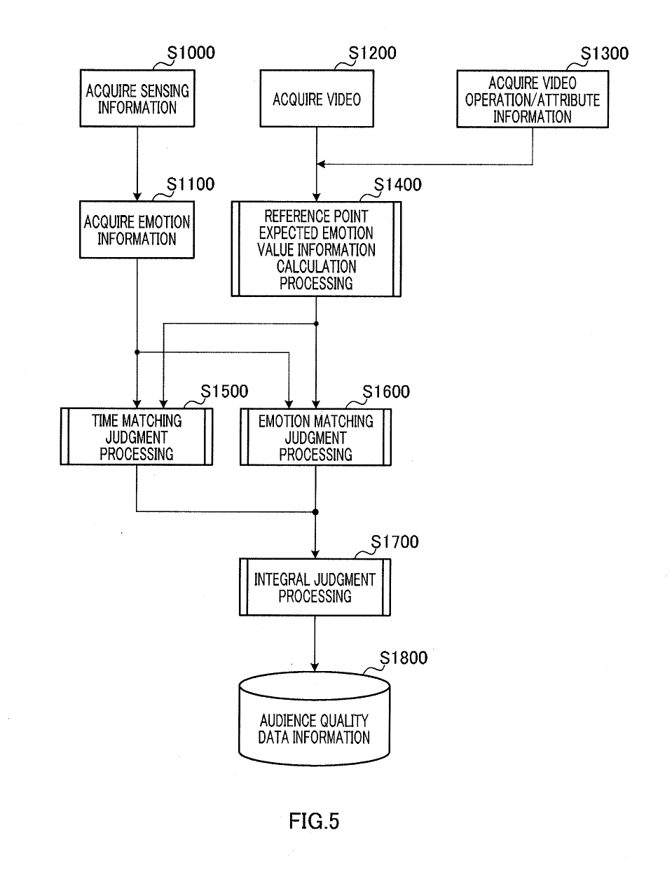

FIG. 6 is an explanatory drawing showing an example of the configuration of emotion information output from emotion information acquisition section 220. Emotion information 610 includes an emotion information number, emotion occurrence time [seconds], and measured emotion value. The emotion occurrence time indicates the time at which an emotion of the type indicated by the corresponding measured emotion value occurred, as elapsed time from a reference time. The reference time is, for example, the video start time. In this case, the emotion occurrence time can be acquired by using a time code that is the absolute time of video content, for example. The reference time is, for example, indicated using the standard time of the location at which viewing is performed, and is added to emotion information 610.

Here, for example, measured emotion value “(−4,−2)” is associated with emotion occurrence time “13 seconds”. This association indicates that emotion information acquisition section 220 acquired measured emotion value “(−4,−2)” from a viewer's biological information obtained 13 seconds after the reference time. That is to say, this association indicates that the emotion “Sad” occurred in the viewer 13 seconds after the reference time.

Provision may be made for emotion information acquisition section 220 to output as emotion information only information in the case of a change of emotion type in the emotion model. In this case, for example, information items having emotion information numbers “002” and “003” are not output since they correspond to the same emotion type as information having emotion information number “001”.

Next, in step S1200, video acquisition section 310 acquires video content viewed by a viewer, and outputs this to reference point expected emotion value calculation section 330. Video content viewed by a viewer is, for example, video program of terrestrial broadcast, satellite broadcast or the like, video data stored on a recording medium such as a DVD or hard disk, a video stream downloaded from the Internet, or the like. Video acquisition section 310 may directly acquire data of video content played back to a viewer, or may acquire separate data of video contents identical to video played back to a viewer.

In step S1300, video operation/attribute information acquisition section 320 acquires video operation information for video content, and video content attribute information. Then video operation/attribute information acquisition section 320 generates video operation/attribute information from the acquired information, and outputs this to reference point expected emotion value calculation section 330. Video operation information is information indicating the contents of operations by a viewer and the time of each operation. Specifically, video operation information indicates, for example, from which channel to which channel a viewer has changed using a remote controller or suchlike interface and when this change was made, when video playback was started and stopped, and so forth. Attribute information is information indicating video content attributes for identifying an object of processing, such as the ID (IDentifier) number, broadcasting channel, genre, and so forth, of video content viewed by a viewer.

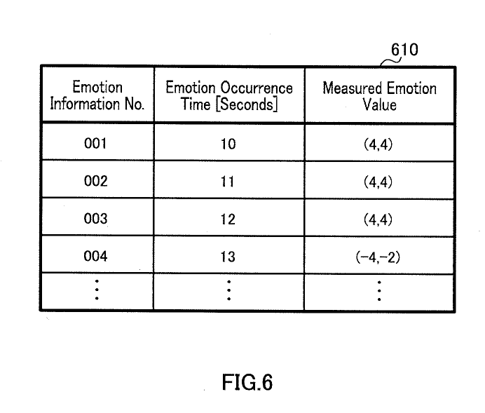

FIG. 7 is an explanatory drawing showing an example of the configuration of video operation/attribute information output from video operation/attribute information acquisition section 320. As shown in FIG. 7, video operation/attribute information 620 includes an Index Number, user ID, content ID, genre, viewing start relative time [seconds], and viewing start absolute time [year/month/day:hr:min:sec]. “Viewing start relative time” indicates elapsed time from the video content start time. “Viewing start absolute time” indicates the video content start time using, for example, the standard time of the location at which viewing is performed.

In video operation/attribute information 620 shown in FIG. 7, viewing start relative time “Null” is associated with content name “Harry Beater”, for example. This association indicates that the corresponding video content is, for example, a live-broadcast video program, and the elapsed time from the video start time to the start of viewing (“viewing start relative time”) is 0 seconds. In this case, a video interval subject to audience quality judgment is synchronous with video being broadcast. On the other hand, viewing start relative time “20 seconds” is associated with content name “Rajukumon”, for example. This association indicates that the corresponding video content is, for example, recorded video data, and viewing was started 20 seconds after the video start time.

In step S1400 in FIG. 5, reference point expected emotion value calculation section 330 executes reference point expected emotion value information calculation processing. Here, reference point expected emotion value information calculation processing is processing that calculates the time and expected emotion value of each reference point from video content and video operation/attribute information.

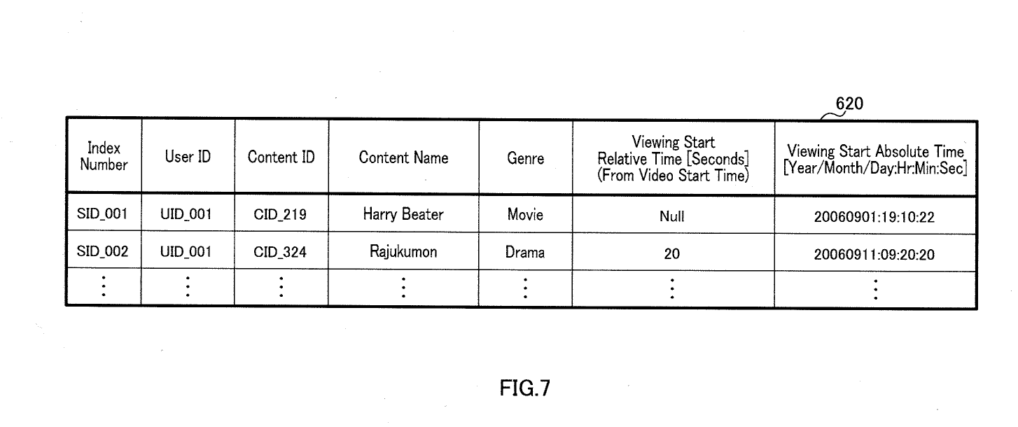

FIG. 8 is a flowchart showing an example of the flow of reference point expected emotion value information calculation processing by reference point expected emotion value calculation section 330, corresponding to step S1400 in FIG. 5. Reference point expected emotion value calculation section 330 acquires video portions, resulting from dividing video content on a unit time S basis, one at a time. Then reference point expected emotion value calculation section 330 executes reference point expected emotion value information calculation processing each time it acquires one video portion. Below, subscript parameter i indicates the number of a reference point at which a particular video portion is detected, and is assumed to have an initial value of 0. Video portions may be scene units.

First, in step S1410, reference point expected emotion value calculation section 330 detects reference point Vpᵢ from a video portion. Then reference point expected emotion value calculation section 330 extracts reference point type Typeᵢ, which is the type of video editing at detected reference point Vpᵢ, and video parameter Pᵢ of that reference point type Typeᵢ.

It is here assumed that “BGM”, “sound effects”, “video shot”, and “camerawork” have been set in advance as reference point type Type. The conversion tables shown in FIG. 3A through FIG. 3D have been prepared corresponding to these reference point types Type. Reference point type information entered in reference point type information management table 342 shown in FIG. 4 corresponds to reference point type Type.

Video parameter Pᵢ is set be forehand as a parameter indicating respective video editing contents. Parameters entered in conversion tables 341 shown in FIG. 3A through FIG. 3D correspond to video parameter Pᵢ. For example, when reference point type Type is “BGM”, reference point expected emotion value calculation section 330 extracts video parameters Pᵢ of key, tempo, pitch, rhythm, harmony and melody. Therefore, in BGM conversion table 341a shown in FIG. 3A, association is performed with reference point type information “BGM” in reference point type information management table 342, and parameters of key, tempo, pitch, rhythm, harmony and melody are entered.

An actual method of detecting reference point Vp for which reference point type Type is “BGM” is described, for example, in “An Impressionistic Metadata Extraction Method for Music Data with Multiple Note Streams” (Naoki Ishibashi et al, The Database Society of Japan Letters, Vol. 2, No. 2), and therefore a description thereof is omitted here.

An actual method of detecting reference point Vp for which reference point type Type is “sound effects” is described, for example, in “Evaluating Impression on Music and Sound Effects in Movies” (Masaharu Hamamura et al, Technical Report of IEICE, 2000-03), and therefore a description thereof is omitted here.

An actual method of detecting reference point Vp for which reference point type Type is “video shot” is described, for example, in “Video Editing based on Movie Effects by Shot Length Transition” (Ryo Takemoto, Atsuo Yoshitaka, and Tsukasa Hirashima, Human Information Processing Study Group, 2006-1-19 to 20), and therefore a description thereof is omitted here.

An actual method of detecting reference point Vp for which reference point type Type is “camerawork” is described, for example, in Japanese Patent Application Laid-Open No. 2003-61112 (Camerawork Detecting Apparatus and Camerawork Detecting Method), and in “Extracting Movie Effects based on Camera Work Detection and Classification” (Ryoji Matsui, Atsuo Yoshitaka, and Tsukasa Hirashima, Technical Report of IEICE, PRMU 2004-167, 2005-01), and therefore a description thereof is omitted here.

Next, in step S1420, reference point expected emotion value calculation section 330 acquires reference point relative start time Tᵢ_{_{—}}_{ST} and reference point relative end time T_{i-EN}. Here, a reference point relative start time is the start time of reference point Vpᵢ in relative time from the video start time, and a reference point relative end time is the end time of reference point Vpᵢ in relative time from the video start time.

Next, in step S1430, reference point expected emotion value calculation section 330 references reference point type information management table 342, and identifies conversion table 341 corresponding to reference point type Typeᵢ. Then reference point expected emotion value calculation section 330 acquires identified conversion table 341. For example, if reference point type Typeᵢ is “BGM”, BGM conversion table 341a shown in FIG. 3A is acquired.

Next, in step S1440, reference point expected emotion value calculation section 330 performs matching between video parameter Pᵢ and parameters entered in acquired conversion table 341, and searches for a parameter that matches video parameter Pᵢ. If a matching parameter is present (S1440: YES), reference point expected emotion value calculation section 330 proceeds to step S1450, whereas if a matching parameter is not present (S1440: NO), reference point expected emotion value calculation section 330 proceeds directly to step S1460 without going through step S1450.

In step S1450, reference point expected emotion value calculation section 330 acquires expected emotion value eᵢ corresponding to a parameter that matches video parameter Pᵢ, and proceeds to step S1460. For example, if reference point type Typeᵢ is “BGM” and video parameters Pᵢ are “Key: minor, Tempo: slow, Pitch: low, Rhythm: fixed, Harmony: complex”, the parameters having index number “M_{—}002” shown in FIG. 3A match. Therefore, “(−4,−2)” is acquired as a corresponding expected emotion value.

In step S1460, reference point expected emotion value calculation section 330 determines whether or not another reference point Vp is present in the video portion. If another reference point Vp is present in the video portion (S1460: YES), reference point expected emotion value calculation section 330 increments the value of parameter i by 1 in step S1470, returns to step S1420, and performs analysis on the next reference point Vpᵢ. If analysis has finished for all reference points Vpᵢ of the video portion (S1460: NO), reference point expected emotion value calculation section 330 generates expected emotion value information, outputs this to time matching judgment section 410 and emotion matching judgment section 420 shown in FIG. 1 (step S1480), and terminates the series of processing steps. Here, expected emotion value information is information that includes reference point relative start time Tᵢ_{_{—}}_{ST} and reference point relative end time Tᵢ_{_{—}}_{EN} of each reference point, the table name of a referenced conversion table, and expected emotion value eᵢ, and associates these for each reference point. The processing procedure then proceeds to steps S1500 and S1600 in FIG. 5.

For parameter matching in step S1440, provision may be made, for example, for the most similar parameter to be judged to be a matching parameter, and for processing to then proceed to step S1450.

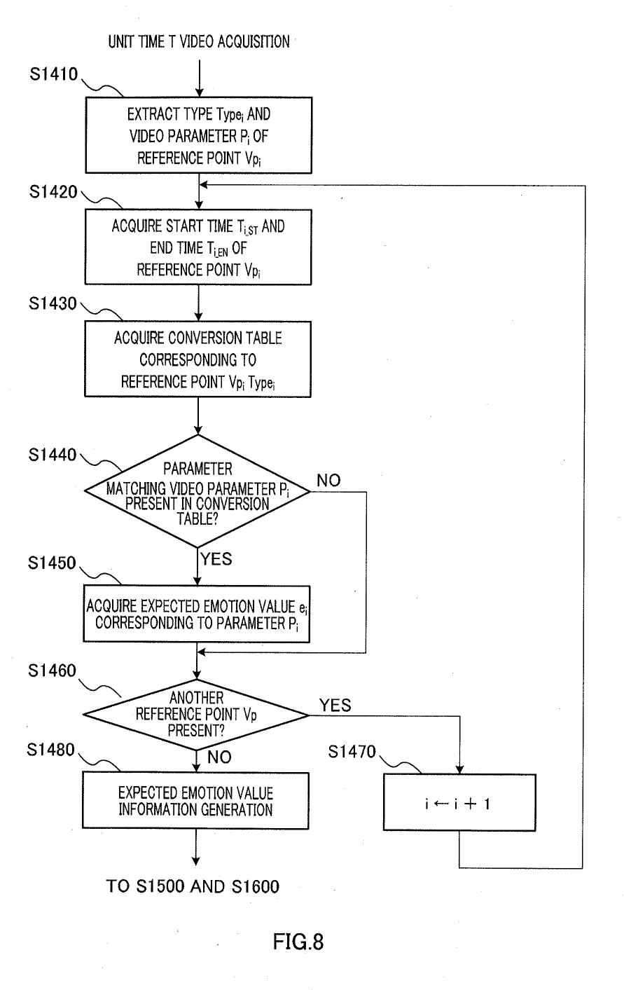

FIG. 9 is an explanatory drawing showing an example of the configuration of reference point expected emotion value information output by reference point expected emotion value calculation section 330. As shown in FIG. 9, expected emotion value information 630 includes a user ID, operation information index number, reference point relative start time [seconds], reference point relative end time [seconds], reference point expected emotion value conversion table name, reference point index number, reference point expected emotion value, reference point start absolute time [year/month/day:hr:min:sec], and reference point end absolute time [year/month/day:hr:min:sec]. “Reference point start absolute time” and “reference point end absolute time” indicate a reference point relative start time and reference point relative end time using, for example, the standard time of the location at which viewing is performed. Reference point expected emotion value calculation section 330 finds a reference point start absolute time and reference point end absolute time, for example, from “viewing start relative time” and “viewing start absolute time” in video operation/attribute information 620 shown in FIG. 7.

In the reference point expected emotion value information calculation processing shown in FIG. 8, expected emotion value information generation section 300 may set provisional reference points at short intervals from the start position to end position of a video portion, identify a place where the emotion type changes, judge that place to be a place at which video editing expected to change a viewer's emotion (hereinafter referred to simply as “video editing”) is present, and treat that place as reference point Vpᵢ.

Specifically, for example, reference point expected emotion value calculation section 330 sets a start portion of a video portion to a provisional reference point, and analyzes BGM, sound effect, video shot, and camerawork contents. Then reference point expected emotion value calculation section 330 searches for corresponding items in the parameters entered in conversion tables 341 shown in FIG. 3A through FIG. 3D, and if a relevant parameter is present, acquires the corresponding expected emotion value. Reference point expected emotion value calculation section 330 repeats such analysis and searching at short intervals toward the end portion of the video portion.

Then, each time an expected emotion value is acquired from the second time onward, reference point expected emotion value calculation section 330 determines whether or not a corresponding emotion type in the two-dimensional emotion model has changed—that is, whether or not video editing is present—between the expected emotion value acquired immediately before and the newly acquired expected emotion value. If the emotion type has changed, reference point expected emotion value calculation section 330 detects the reference point at which the expected emotion value was acquired as reference point Vpᵢ, and detects the type of the configuration element of the video portion that is the source of the change of emotion type as reference point type Typeᵢ.

If reference point expected emotion value calculation section 330 has already performed reference point analysis in the immediately preceding video portion, reference point expected emotion value calculation section 330 may determine whether or not there is a change of emotion type at a point in time at which the first expected emotion value was acquired, using the analysis result.

When emotion information and expected emotion value information are input to audience quality data generation section 400 in this way, processing proceeds to step S1500 and step S1600 in FIG. 5.

First, step S1500 in FIG. 5 will be described. In step S1500 in FIG. 5, time matching judgment section 410 executes time matching judgment processing. Here, time matching judgment processing is processing that judges whether or not there is time matching between emotion information and expected emotion value information.

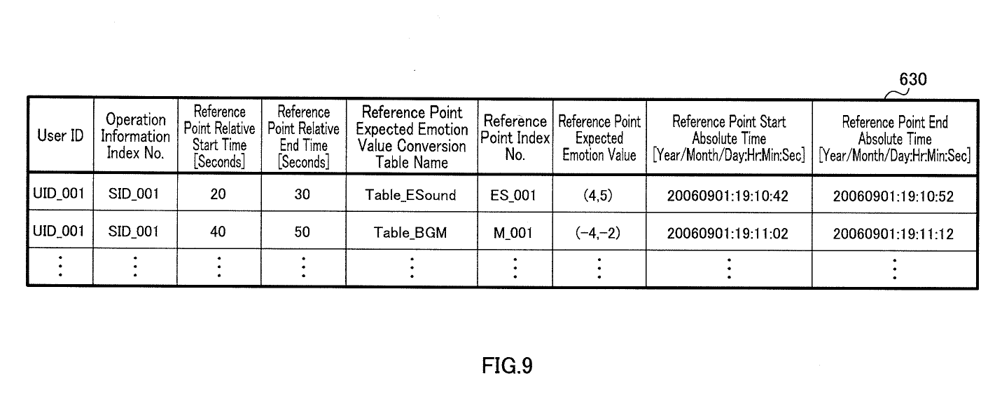

FIG. 10 is a flowchart showing an example of the flow of time matching judgment processing by time matching judgment section 410, corresponding to step S1500 in FIG. 5. Time matching judgment section 410 executes the time matching judgment processing described below for individual video portions on a video content unit time S basis.

First, in step S1510, time matching judgment section 410 acquires expected emotion value information corresponding to a unit time S video portion. If there are a plurality of relevant reference points, expected emotion value information is acquired for each.

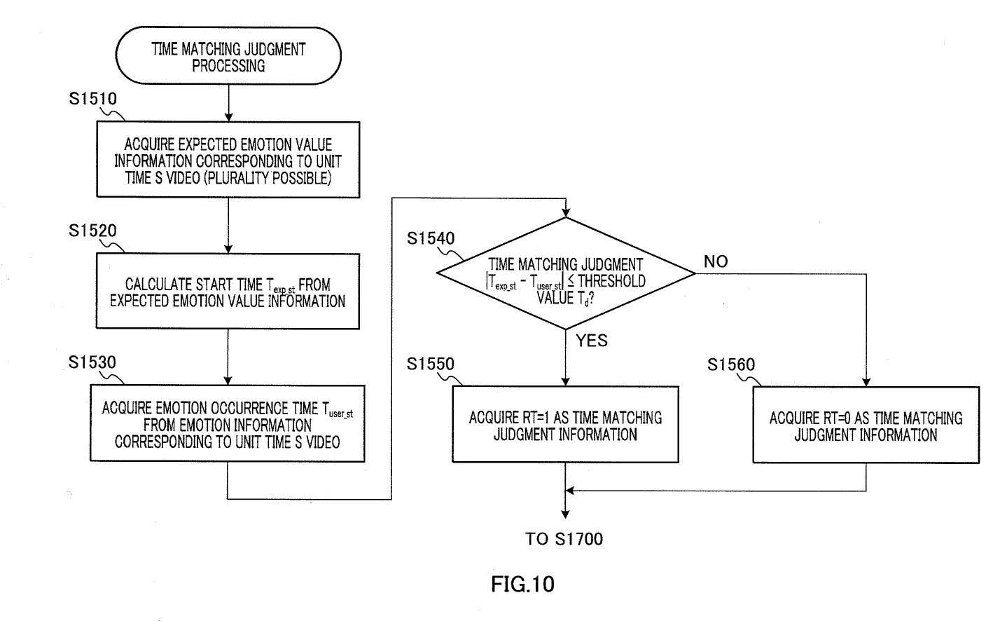

FIG. 11 is an explanatory drawing showing the presence of a plurality of reference points in one unit time. A case is shown here in which reference point type Type₁ “BGM” reference point Vp₁ with time T₁ as a start time, and reference point type Type₂ “video shot” reference point Vp₂ with time T₂ as a start time, are detected in a unit time S video portion. A case is shown in which expected emotion value e₁ corresponding to reference point Vp₁ is acquired, and expected emotion value e₂ corresponding to reference point Vp₂ is acquired.

In step S1520 in FIG. 10, time matching judgment section 410 calculates reference point relative start time Tₑₓₚ_{_{—}}ₛₜ of a reference point representing a unit time S video portion from expected emotion value information. Specifically, time matching judgment section 410 takes a reference point at which the emotion type changes as a representative reference point, and calculates the corresponding reference point relative start time as reference point relative start time Tₑₓₚ_{_{—}}ₛₜ.

If video content is real-time broadcast video, time matching judgment section 410 assumes that reference point relative start time Tₑₓₚ_{_{—}}ₛₜ=reference point start absolute time. And if video content is recorded video, time matching judgment section 410 assumes that reference point relative start time Tₑₓₚ_{_{—}}ₛₜ=reference point relative start time. When there are a plurality of reference points Vp at which the emotion type changes, as shown in FIG. 11, the earliest time—that is, the time at which the emotion type first changes—is decided upon as reference point relative start time Tₑₓₚ_{_{—}}ₛₜ.

Next, in step S1530, time matching judgment section 410 identifies emotion information corresponding to a unit time S video portion, and acquires a time at which the emotion type changes in the unit time S video portion from the identified emotion information as emotion occurrence time Tᵤₛₑᵣ_{_{—}}ₛₜ. If there are a plurality of relevant emotion occurrence times, the earliest time can be acquired in the same way as with reference point relative start time Tₑₓₚₛₜ, for example. In this case, provision is made for reference point relative start time Tₑₓₚ_{_{—}}ₛₜ and emotion occurrence time Tᵤₛₑᵣ_{_{—}}ₛₜ to be expressed using the same time system.

Specifically, in the case of video content provided by real-time broadcasting, for example, a time obtained by adding the reference point relative start time to the viewing start absolute time is taken as the reference point absolute start time. On the other hand, in the case of stored video content, a time obtained by subtracting the viewing start relative time from the viewing start absolute time is taken as the reference point absolute start time.

For example, if the reference point relative start time is “20 seconds” and the viewing start absolute time is “20060901:19:10:10” for real-time broadcast video content, the reference point absolute start time is “20060901:19:10:30”. And if, for example, the reference point relative start time is “20 seconds” and the viewing start absolute time is “20060901:19:10:10” for stored video content, the reference point absolute start time is “20060901:19:10:20”.

On the other hand, for an emotion occurrence time measured from a viewer, time matching judgment section 410 adds a value entered in emotion information 610 to a reference time, and substitutes this for an absolute time representation.

Next, in step S1540, time matching judgment section 410 calculates the time difference between reference point relative start time Tₑₓₚ_{_{—}}ₛₜ and emotion occurrence time Tᵤₛₑᵣ_{_{—}}ₛₜ, and judges whether or not there is time matching in the unit time S video portion from matching of these two times. Specifically, time matching judgment section 410 determines whether or not the absolute value of the difference between reference point relative start .time Tₑₓₚ_{_{—}}ₛₜ and emotion occurrence time Tᵤₛₑᵣ_{_{—}}ₛₜ is less than or equal to predetermined threshold value T_{d}. Then time matching judgment section 410 proceeds to step S1550 if the absolute value of the difference is less than or equal to threshold value T_{d} (S1540: YES), or proceeds to step S1560 if the absolute value of the difference exceeds threshold value T_{d} (S1540: NO).

In step S1550, time matching judgment section 410 judges that there is time matching in the unit time S video portion, and sets time matching judgment information RT indicating whether or not there is time matching to “1”. That is to say, time matching judgment information RT=1 is acquired as a time matching judgment result. Then time matching judgment section 410 outputs time matching judgment information RT, and expected emotion value information and emotion information used in the acquisition of this time matching judgment information RT, to integral judgment section 430, and proceeds to step S1700 in FIG. 5.

On the other hand, in step S1560, time matching judgment section 410 judges that there is no time matching in the unit time S video portion, and sets time matching judgment information RT indicating whether or not there is time matching to “0”. That is to say, time matching judgment information RT=0 is acquired as a time matching judgment result. Then time matching judgment section 410 outputs time matching judgment information RT, and expected emotion value information and emotion information used in the acquisition of this time matching judgment information RT, to integral judgment section 430, and proceeds to step S1700 in FIG. 5.

Equation (1) below, for example, can be used in the processing in above steps S1540 through S1560.

$$RT = \{ \begin{matrix}1 , & if \vert {T}_{exp\_st} - {T}_{user\_st} \vert \leq {T}_{d} \\ 0 , & if \vert {T}_{exp\_st} - {T}_{user\_st} \vert > {T}_{d}\end{matrix} \qquad ( 1 )$$

Step S1600 in FIG. 5 will now be described. In step S1600 in FIG. 5, emotion matching judgment section 420 executes emotion matching judgment processing. Here, emotion matching judgment processing is processing that judges whether or not there is emotion matching between emotion information and expected emotion value information.

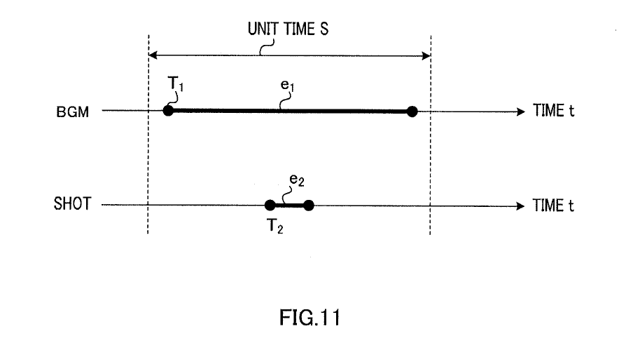

FIG. 12 is a flowchart showing an example of the flow of emotion matching judgment processing by emotion matching judgment section 420. Emotion matching judgment section 420 executes the emotion matching judgment processing described below for individual video portions on a video content unit time S basis.

In step S1610, emotion matching judgment section 420 acquires expected emotion value information corresponding to a unit time S video portion. If there are a plurality of relevant reference points, expected emotion value information is acquired for each.

Next, in step S1620, emotion matching judgment section 420 calculates expected emotion value Eₑₓₚ representing a unit time S video portion from expected emotion value information. When there are a plurality of expected emotion values eᵢ as shown in FIG. 11, emotion matching judgment section 420 synthesizes each expected emotion value eᵢ by multiplying weight w set in advance for each reference point type Type by the respective emotion value eᵢ. If a weight of reference point type Type corresponding to an individual emotion value eᵢ is designated wᵢ, and the total number of respective emotion values eᵢ is designated N, emotion matching judgment section 420 decides upon expected emotion value Eₑₓₚ using Equation (2) below, for example.

$${E}_{exp} = {\sum }_{i = 1}^{N} {w}_{i} {e}_{i} \qquad ( 2 )$$

Weight wᵢ of reference point type Type corresponding to an individual emotion value eᵢ is set so as to satisfy Equation (3) below.

$${\sum }_{i = 1}^{N} {w}_{i} = 1 \qquad ( 3 )$$

Alternatively, emotion matching judgment section 420 may decide upon expected emotion value Eₑₓₚ by means of Equation (4) below using weight w set as a predetermined fixed value for each reference point type Type. In this case, weight wᵢ of reference point type Type corresponding to an individual emotion value eᵢ need not satisfy Equation (3).

$${E}_{exp} = \frac{{\sum }_{i = 1}^{N} {w}_{i} {e}_{i}}{{\sum }_{i = 1}^{N} {w}_{i}} \qquad ( 4 )$$

For example, in the example shown in FIG. 11, it is assumed that expected emotion value e₁ is acquired for reference point Vp₁ of reference point type Type₁ “BGM” with time T₁ as a start time, and expected emotion value e₂ is acquired for reference point Vp₂ of reference point type Type₂ “video shot” with time T₂ as a start time. Also, it is assumed that relative weightings of 7:3 are set for reference point types Type “BGM” and “video shot”. In this case, expected emotion value Eₑₓₚ is calculated as shown in Equation (5) below.

Eₑₓₚ=0.7e₁+0.3e₂ (5)

Next, in step S1630, emotion matching judgment section 420 identifies emotion information corresponding to a unit time S video portion, and acquires measured emotion value Eᵤₛₑᵣ of the unit time S video portion from the identified emotion information. If there are a plurality of relevant measured emotion values, the plurality of measured emotion values can be combined in the same way as with expected emotion value Eₑₓₚ, for example.

Then, in step S1640, emotion matching judgment section 420 calculates the difference between expected emotion value Eₑₓₚ and measured emotion value Eᵤₛₑᵣ, and judges whether or not there is emotion matching in the unit time S video portion from matching of these two values. Specifically, emotion matching judgment section 420 determines whether or not the absolute value of the difference between expected emotion value Eₑₓₚ and measured emotion value Eᵤₛₑᵣ is less than or equal to predetermined threshold value E_{d} of a distance in the two-dimensional space of two-dimensional emotion model 600. Then emotion matching judgment section 420 proceeds to step S1650 if the absolute value of the difference is less than or equal to threshold value E_{d} (S1640: YES), or proceeds to step S1660 if the absolute value of the difference exceeds threshold value E_{d} (S1640: NO).

In step S1650, emotion matching judgment section 420 judges that there is emotion matching in the unit time S video portion, and sets emotion matching judgment information RE indicating whether or not there is emotion matching to “1”. That is to say, emotion matching judgment information RE=1 is acquired as an emotion matching judgment result. Then emotion matching judgment section 420 outputs emotion matching judgment information RE, and expected emotion value information and emotion information used in the acquisition of this emotion matching judgment information RE, to integral judgment section 430, and proceeds to step S1700 in FIG. 5.

On the other hand, in step S1660, emotion matching judgment section 420 judges that there is no emotion matching in the unit time S video portion, and sets emotion matching judgment information RE indicating whether or not there is emotion matching to “0”. That is to say, emotion matching judgment information RE=0 is acquired as an emotion matching judgment result. Then emotion matching judgment section 420 outputs emotion matching judgment information RE, and expected emotion value information and emotion information used in the acquisition of this emotion matching judgment information RE, to integral judgment section 430, and proceeds to step S1700 in FIG. 5.

Equation (6) below, for example, can be used in the processing in above steps S1640 through S1660.

$$RE = \{ \begin{matrix}1 , & if \vert {E}_{exp} - {E}_{user} \vert \leq {E}_{d} \\ 0 , & if \vert {E}_{exp} - {E}_{user} \vert > {E}_{d}\end{matrix} \qquad ( 6 )$$

In this way, expected emotion value information and emotion information, and time matching judgment information RT and emotion matching judgment information RE, are input to integral judgment section 430 for each video portion resulting from dividing video content on a unit time S basis. Integral judgment section 430 stores these input items of information in audience quality data storage section 500.

Since time matching judgment information RT and emotion matching judgment information RE can each have a value of “1” or “0”, there are four possible combinations of time matching judgment information RT and emotion matching judgment information RE values.

The presence of both time matching and emotion matching indicates that, when video content is viewed, an emotion expected to occur on the basis of video editing in a viewer who views content with interest has occurred in the viewer at a place where relevant video editing is present. Therefore, it can be assumed that the relevant video portion was viewed with interest by the viewer.

Furthermore, absence of either time matching or emotion matching indicates that, when video content is viewed, an emotion expected to occur on the basis of video editing in a viewer who views content with interest has not occurred in the viewer, and it is highly probable that whatever emotion occurred was not due to video editing. Therefore, it can be assumed that the relevant video portion was not viewed with interest by the viewer.

However, if either time matching or emotion matching is present but the other is absent, it is difficult to make an assumption as to whether or not the viewer viewed the relevant video portion of video content with interest.

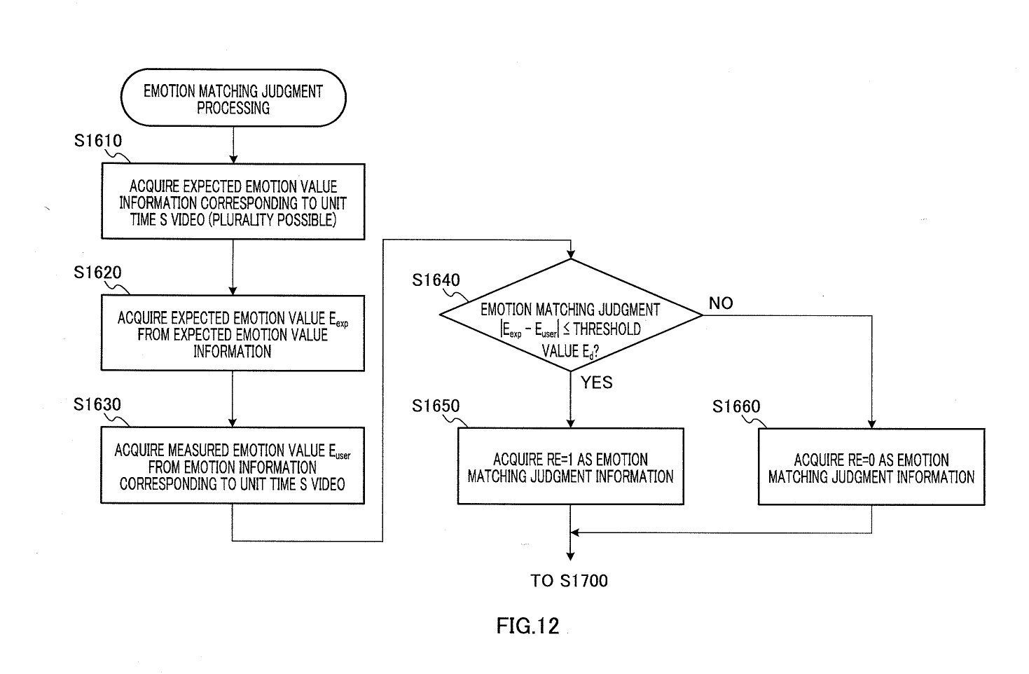

FIG. 13 is an explanatory drawing showing an example of a case in which there is time matching but there is no emotion matching. Below, the line type of a reference point corresponds to an emotion type, and an identical line type indicates an identical emotion type, while different line types indicate different emotion types. In the example shown in FIG. 13, reference point relative start time Tₑₓₚ_{_{—}}ₛₜ and emotion occurrence time Tᵤₛₑᵣ_{_{—}}ₛₜ approximately match, but expected emotion value Eₑₓₚ and measured emotion value Eᵤₛₑᵣ indicate different emotion types.

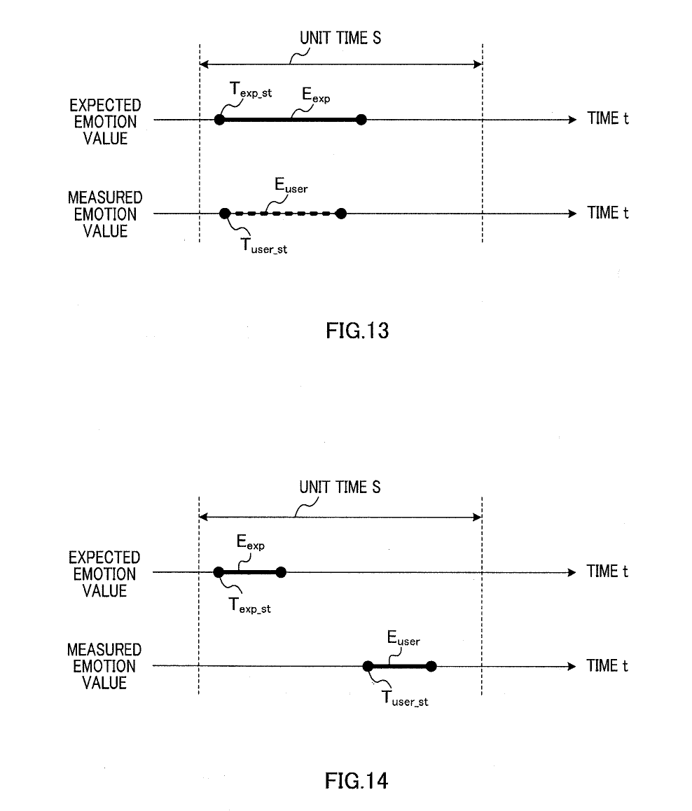

On the other hand, FIG. 14 is an explanatory drawing showing an example of a case in which there is emotion matching but there is no time matching. In the example shown in FIG. 14, the expected emotion value Eₑₓₚ and measured emotion value Eᵤₛₑᵣ emotion types match, but reference point relative start time Tₑₓₚ_{_{—}}ₛₜ and emotion occurrence time Tᵤₛₑᵣ_{_{—}}ₛₜ differ greatly.

Taking cases such as shown in FIG. 13 and FIG. 14 into consideration, in step S1700 in FIG. 5 integral judgment section 430 executes integral judgment processing on each video portion resulting from dividing video content on a unit time S basis. Here, integral judgment processing is processing that performs final audience quality judgment by integrating a time matching judgment result and emotion matching judgment result.

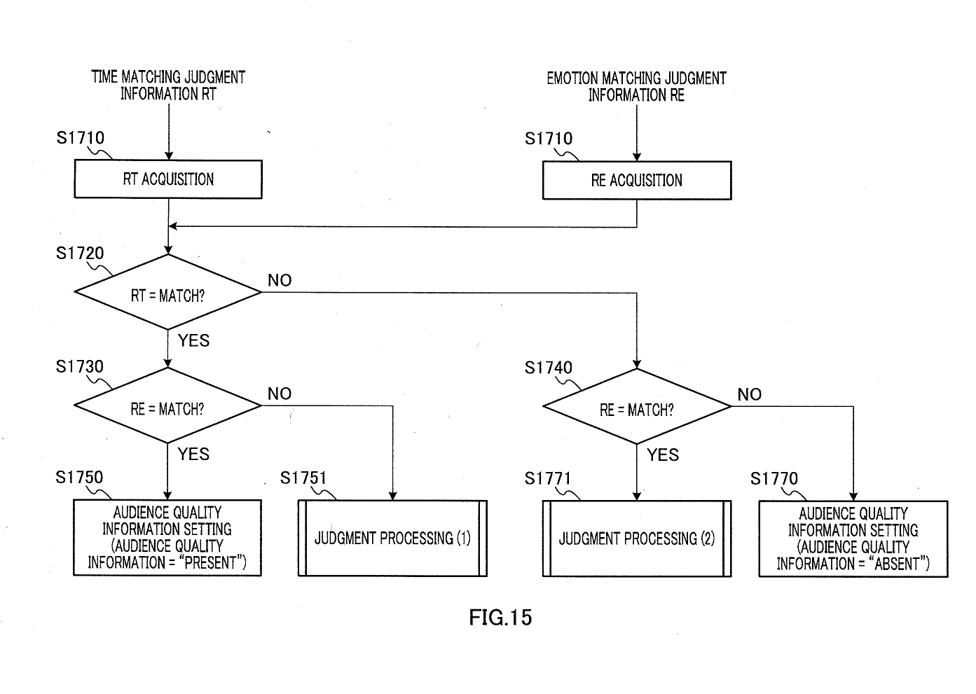

FIG. 15 is a flowchart showing an example of the flow of integral judgment processing by integral judgment section 430, corresponding to step S1700 in FIG. 5.

First, in step S1710, integral judgment section 430 selects one video portion resulting from dividing video content on a unit time S basis, and acquires corresponding time matching judgment information RT and emotion matching judgment information RE.

Next, in step S1720, integral judgment section 430 determines time matching. Integral judgment section 430 proceeds to step S1730 if the value of time matching judgment information RT is “1” and there is time matching (S1720: YES), or proceeds to step S1740 if the value of time matching judgment information RT is “0” and there is no time matching (S1720: NO).

In step S1730, integral judgment section 430 determines emotion matching. Integral judgment section 430 proceeds to step S1750 if the value of emotion matching judgment information RE is “1” and there is emotion matching (S1730: YES), or proceeds to step S1751 if the value of emotion matching judgment information RE is “0” and there is no emotion matching (S1730: NO).

Instep S1750, since there is both time matching and emotion matching, integral judgment section 430 sets audience quality information for the relevant video portion to “present”, and acquires audience quality information. Then integral judgment section 430 stores the acquired audience quality information in audience quality data storage section 500.

On the other hand, in step S1751, integral judgment section 430 executes time match emotion mismatch judgment processing (hereinafter referred to as “judgment processing (1)”). Judgment processing (1) is processing that, since there is time matching but no emotion matching, performs audience quality judgment by performing more detailed analysis. Judgment processing (1) will be described later herein.

In step S1740, integral judgment section 430 determines emotion matching, and proceeds to step S1770 if the value of emotion matching judgment information RE is “0” and there is no emotion matching (S1740: NO), or proceeds to step S1771 if the value of emotion matching judgment information RE is “1” and there is emotion matching (S1740: YES).

In step S1770, since there is neither time matching nor emotion matching, integral judgment section 430 sets audience quality information for the relevant video portion to “absent”, and acquires audience quality information. Then integral judgment section 430 stores the acquired audience quality information in audience quality data storage section 500.

On the other hand, in step S1771, since there is emotion matching but no time matching, integral judgment section 430 executes emotion match time mismatch judgment processing (hereinafter referred to as “judgment processing (2)”). Judgment processing (2) is processing that performs audience quality judgment by performing more detailed analysis. Judgment processing (2) will be described later herein.

Judgment processing (1) will now be described.

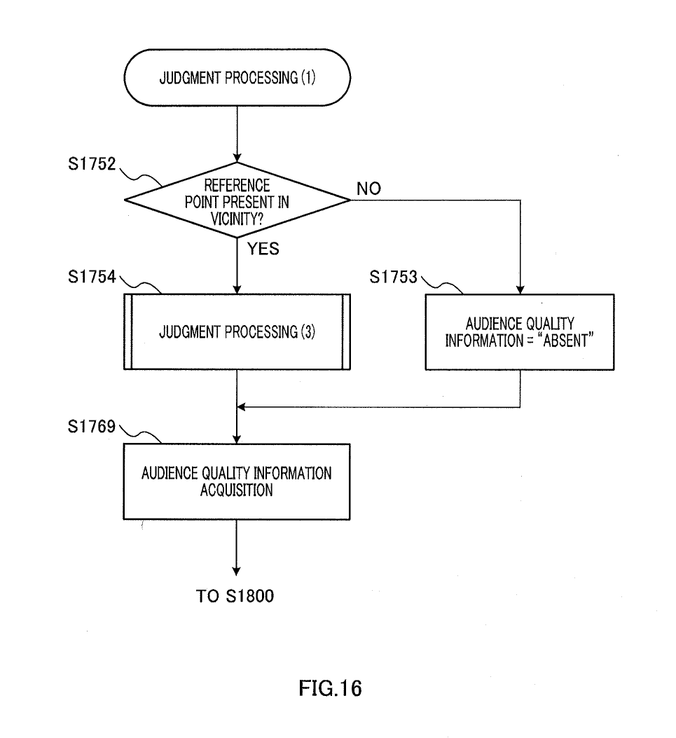

FIG. 16 is a flowchart showing an example of the flow of judgment processing (1) by integral judgment section 430, corresponding to step S1751 in FIG. 15.

In step S1752, integral judgment section 430 references audience quality data storage section 500, and determines whether or not a reference point is present in another video portion in the vicinity of the video portion that is the object of audience quality judgment (hereinafter referred to as “judgment object”). Integral judgment section 430 proceeds to step S1753 if a relevant reference point is not present (S1752: NO), or proceeds to step S1754 if a relevant reference point is present (S1752: YES).

Integral judgment section 430 sets a range of other video portions in the vicinity of the judgment object according to whether audience quality data information is generated in real-time or is generated in non-real-time for video content viewing.

When audience quality data information is generated in real-time for video content viewing, integral judgment section 430 takes a range extending back for a period of M unit times S from the judgment object as an above-mentioned other video portion range, and searches for a reference point in this range. That is to say, viewed from the judgment object, past information in a range of S×M is used.

On the other hand, when audience quality data information is generated in non-real-time for video content viewing, integral judgment section 430 can use a measured emotion value obtained in a video portion later than the judgment object. Therefore, not only past information but also future information as viewed from the judgment object can be used, and, for example, integral judgment section 430 takes a range of S×M centered on and preceding and succeeding the judgment object as an above-mentioned other video portion range, and searches for a reference point in this range. The value of M can be set arbitrarily, and is set in advance, for example, as an integer such as “5”. The reference point search range may also be set as a length of time.

In step S1753, since a reference point is not present in a video portion in the vicinity of the judgment object, integral judgment section 430 sets audience quality information of the relevant video portion to “absent”, and proceeds to step S1769.

In step S1754, since a reference point is present in a video portion in the vicinity of the judgment object, integral judgment section 430 executes time match vicinity reference point presence judgment processing (hereinafter referred to as “judgment processing (3)”). Judgment processing (3) is processing that performs audience quality judgment taking the presence or absence of time matching at a reference point into consideration.

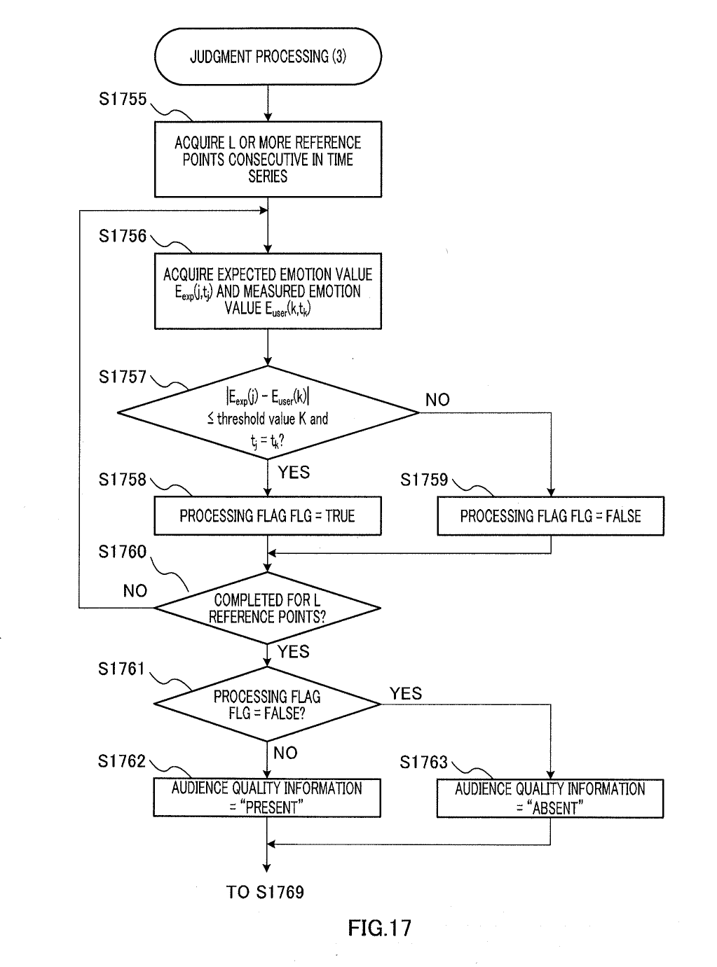

FIG. 17 is a flowchart showing an example of the flow of judgment processing (3) by integral judgment section 430, corresponding to step S1754 in FIG. 16.

First, in step S1755, integral judgment section 430 searches for and acquires a representative reference point from respective L or more video portions that are consecutive in a time series from audience quality data storage section 500. Here, parameters indicating the number of a reference point in the search range and the number of measured emotion value Eᵤₛₑᵣ are designated j and k respectively. Parameters j and k each have values {0, 1, 2, 3, . . . L}.

Next, in step S1756, integral judgment section 430 acquires j′th reference point expected emotion value Eₑₓₚ(j,tⱼ) and k′th measured emotion value Eᵤₛₑᵣ (k, tₖ) from expected emotion value information and emotion information stored in audience quality data storage section 500. Here, time tⱼ and time tₖ are the times at which an expected emotion value and measured emotion value were obtained respectively—that is, the times at which the corresponding emotions occurred.

Next, in step S1757, integral judgment section 430 calculates the absolute value of the difference between expected emotion value Eₑₓₚ(j) and measured emotion value Eᵤₛₑᵣ(k) in the same video portion. Then integral judgment section 430 determines whether or not the absolute value of the difference between expected emotion value Eₑₓₚ and measured emotion value Eᵤₛₑᵣ is less than or equal to predetermined threshold value K of a distance in the two-dimensional space of two-dimensional emotion model 600, and time tⱼ and time tₖ match. Integral judgment section 430 proceeds to step S1758 if the absolute value of the difference is less than or equal to threshold value K, and time tⱼ and time tₖ match, (S1757: YES), or proceeds to step S1759 if the absolute value of the difference exceeds threshold value K, or time tⱼ and time tₖ do not match, (S1757: NO). Time tⱼ and time tₖ may, for example, be judged to match if the absolute value of the difference between time tⱼ and time tₖ is less than a predetermined threshold value, and judged not to match if this difference is greater than the threshold value.

In step S1758, integral judgment section 430 judges that emotions are not greatly different and occurrence times match, sets a value of “1” indicating TRUE logic in processing flag FLG for the j′th reference point, and proceeds to step S1760. However, if a value of “0” indicating FALSE logic in processing flag FLG has already been set in processing flag FLG in step S1759 described later herein, this setting is left unchanged.

In step S1759, integral judgment section 430 judges that emotions differ greatly or occurrence times do not match, sets a value of “0” indicating FALSE logic in processing flag FLG for the j′th reference point, and proceeds to step S1760.

Next, in step S1760, integral judgment section 430 determines whether or not processing flag FLG setting processing has been completed for all L reference points. If processing has not yet been completed for all L reference points—that is, if parameter j is less than L—(S1760: NO), integral judgment section 430 increments the values of parameters j and k by 1, and returns to step S1756. Integral judgment section 430 repeats the processing in steps S1756 through S1760, and proceeds to step S1761 when processing is completed for all L reference points (S1760: YES).

In step S1761, integral judgment section 430 determines whether or not processing flag FLG has been set to a value of “0” (FALSE). Integral judgment section 430 proceeds to step S1762 if processing flag FLG has not been set to a value of “0” (S1761: NO), or proceeds to step S1763 if processing flag FLG has been set to a value of “0” (S1761: YES).

In step S1762, since, although there is no emotion matching between expected emotion value information and emotion information, there is time matching consecutively at L reference points in the vicinity, integral judgment section 430 judges that the viewer viewed the video portion that is the judgment object with interest, and sets the judgment object audience quality information to “present”. The processing procedure then proceeds to step S1769 in FIG. 16.

On the other hand, in step S1763, since emotions do not match between expected emotion value information and emotion information, and there is no time matching consecutively at L reference points in the vicinity, integral judgment section 430 judges that the viewer did not view the video portion that is the judgment object with interest, and sets the judgment object audience quality information to “absent”. The processing procedure then proceeds to step S1769 in FIG. 16.

In step S1769 in FIG. 16, integral judgment section 430 acquires audience quality information set in step S1753 in FIG. 16 and step S1762 or step S1763 in FIG. 17, and stores this information in audience quality data storage section 500. The processing procedure then proceeds to step S1800 in FIG. 5.

In this way, integral judgment section 430 performs audience quality judgment for a video portion for which there is time matching but there is no emotion matching by means of judgment processing (3).

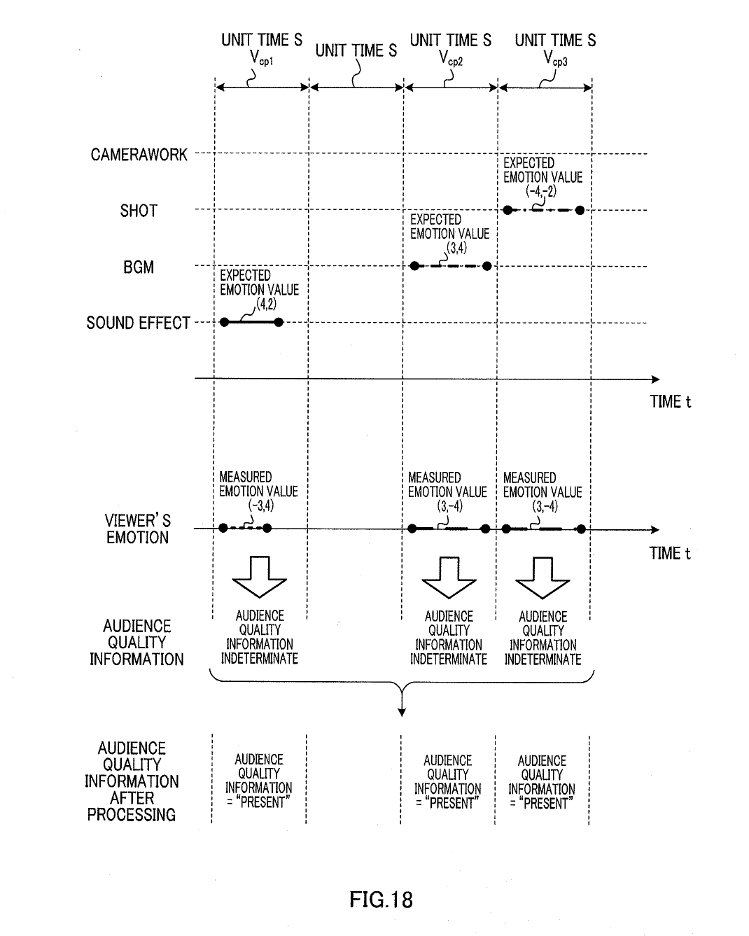

FIG. 18 is an explanatory drawing showing how audience quality information is set by means of judgment processing (3). Here, a case is illustrated in which audience quality data information is generated in real-time, parameter L=3, and threshold value K=9. Also, V_{cp1} indicates a sound effect reference point detected in a judgment object, and V_{cp2} and V_{cp3} indicate reference points detected from BGM and a video shot respectively in a video portion in the vicinity of the judgment object.

As shown in FIG. 18, it is assumed that expected emotion value (4,2) and measured emotion value (−3,4) are acquired from the judgment object in which reference point V_{cp1} was detected; it is assumed that expected emotion value (3,4) and measured emotion value (3,−4) are acquired from the video portion in which reference point V_{cp2} was detected; and it is assumed that expected emotion value (−4,−2) and measured emotion value (3,−4) are acquired from the video portion in which reference point V_{cp3} was detected. With regard to the judgment object in which reference point V_{cp1} was detected, since there is time matching but there is no emotion matching, audience quality information is indeterminate until judgment processing (1) shown in FIG. 16 is executed. The same also applies to the video portions in which reference points V_{cp2} and V_{cp3} were detected. When judgment processing (3) shown in FIG. 17 is executed in this state, since there is time matching at reference points V_{cp2} and V_{cp3} in the vicinity, audience quality information of the judgment object in which reference point V_{cp1} was detected is judged as “present”. The same also applies to a case in which reference points V_{cp1} and V_{cp3} are detected as reference points in the vicinity of reference point V_{cp2}, and a case in which reference points V_{cp1} and V_{cp2} are detected as reference points in the vicinity of reference point V_{cp3}.

Judgment processing (2) will now be described.

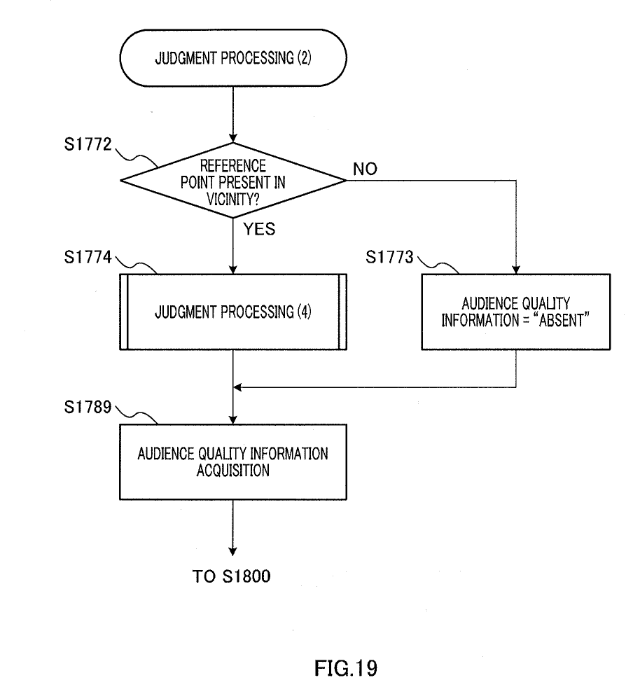

FIG. 19 is a flowchart showing an example of the flow of judgment processing (2) by integral judgment section 430, corresponding to step S1771 in FIG. 15.

In step S1772, integral judgment section 430 references audience quality data storage section 500, and determines whether or not a reference point is present in another video portion in the vicinity of the judgment object. Integral judgment section 430 proceeds to step S1773 if a relevant reference point is not present (S1772: NO), or proceeds to step S1774 if a relevant reference point is present (S1772: YES).

How integral judgment section 430 sets another video portion in the vicinity of the judgment object differs according to whether audience quality data information is generated in real-time or is generated in non-real-time, in the same way as in judgment processing (1) shown in FIG. 16.

In step S1773, since a reference point is not present in a video portion in the vicinity of the judgment object, integral judgment section 430 sets audience quality information of the relevant video portion to “absent”, and proceeds to step S1789.

In step S1774, since a reference point is present in a video portion in the vicinity of the judgment object, integral judgment section 430 executes emotion match vicinity reference point presence judgment processing (hereinafter referred to as “judgment processing (4)”). Judgment processing (4) is processing that performs audience quality judgment taking the presence or absence of emotion matching at the relevant reference point into consideration.

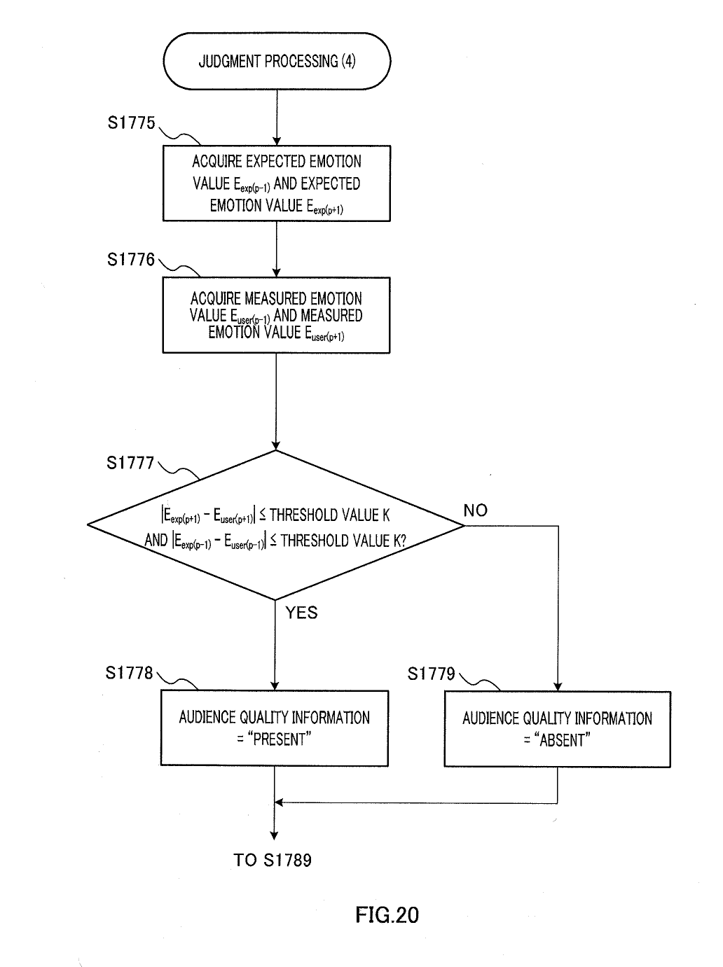

FIG. 20 is a flowchart showing an example of the flow of judgment processing (4) by integral judgment section 430, corresponding to step S1774 in FIG. 19. Here, the number of a judgment object reference point is indicated by parameter p.

First, in step S1775, integral judgment section 430 acquires expected emotion value Eₑₓₚ₍ₚ₋₁₎ of the reference point one before the judgment object (reference point p−1) from audience quality data storage section 500. Also, integral judgment section 430 acquires expected emotion value Eₑₓₚ₍ₚ₊₁₎ of the reference point one after the judgment object (reference point p₊1) from audience quality data storage section 500.

Next, in step S1776, integral judgment section 430 acquires measured emotion value Eᵤₛₑᵣ₍ₚ₋₁₎ measured in the same video portion as the reference point one before the judgment object (reference point p−1) from audience quality data storage section 500. Also, integral judgment section 430 acquires measured emotion value Eᵤₛₑᵣ₍ₚ₊₁₎ measured in the same video portion as the reference point one after the judgment object (reference point p+1) from audience quality data storage section 500.

Next, in step S1777, integral judgment section 430 calculates the absolute value of the difference between expected emotion value Eₑₓₚ₍ₚ₊₁₎ and measured emotion value Eᵤₛₑᵣ₍ₚ₊₁₎, and the absolute value of the difference between expected emotion value Eₑₓₚ₍ₚ₋₁₎ and measured emotion value Eᵤₛₑᵣ₍ₚ₋₁₎. Then integral judgment section 430 determines whether or not both values are less than or equal to predetermined threshold value K of a distance in the two-dimensional space of two-dimensional emotion model 600. Here, the maximum value for which emotions can be said to match is set in advance for threshold value K. Integral judgment section 430 proceeds to step S1778 if both values are less than or equal to threshold value K (S1777: YES), or proceeds to step S1779 if both values are not less than or equal to threshold value K (S1777: NO).

In step S1778, since there is no time matching between expected emotion value information and emotion information, but there is emotion matching in a video portion of a preceding and succeeding reference points, integral judgment section 430 judges that the viewer viewed the video portion that is the judgment object with interest, and sets judgment object audience quality information to “present”. Then the processing procedure proceeds to step S1789 in FIG. 19.

On the other hand, in step S1779, since there is no time matching between expected emotion value information and emotion information, and there is no emotion matching in at least one of the video portions of preceding and succeeding reference points, integral judgment section 430 judges that the viewer did not view the video portion that is the judgment object with interest, and sets judgment object audience quality information to “absent”. Then the processing procedure proceeds to step S1789 in FIG. 19.

In step S1789 in FIG. 19, integral judgment section 430 acquires audience quality information set in step S1773 in FIG. 19 and step S1778 or step S1779 in FIG. 20, and stores this information in audience quality data storage section 500. The processing procedure then proceeds to step S1800 in FIG. 5.

In this way, integral judgment section 430 performs audience quality judgment for a video portion for which there is emotion matching but there is no time matching by means of judgment processing (4).

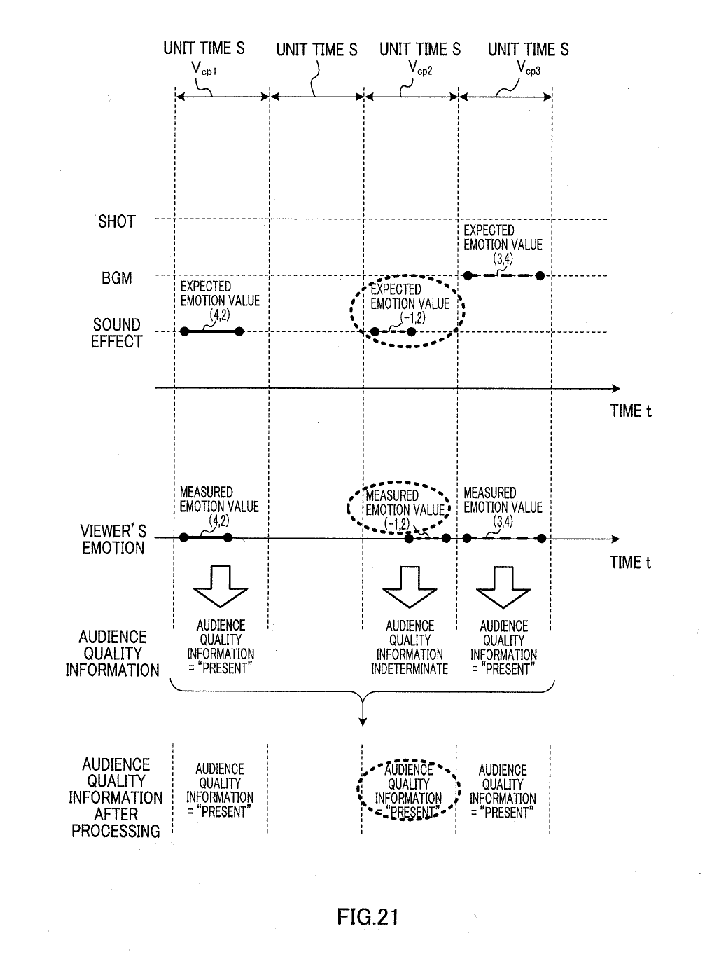

FIG. 21 is an explanatory drawing showing how audience quality information is set by means of judgment processing (4). Here, a case is illustrated in which audience quality data information is generated in non-real-time, and one reference point before and one reference point after the judgment object are used for judgment. Also, V_{cp2} indicates a sound effect reference point detected in the judgment object, and V_{cp1} and V_{cp3} indicate reference points detected from a sound effect and BGM respectively in a video portion in the vicinity of the judgment object.

As shown in FIG. 21, it is assumed that expected emotion value (−1,2) and measured emotion value (−1,2) are acquired from the judgment object in which reference point V_{cp2} was detected; it is assumed that expected emotion value (4,2) and measured emotion value (4,2) are acquired from the video portion in which reference point V_{cp1} was detected; and it is assumed that expected emotion value (3,4) and measured emotion value (3,4) are acquired from the video portion in which reference point V_{cp3} was detected. With regard to the judgment object in which reference point V_{cp2} was detected, since there is emotion matching but there is no time matching, audience quality information is indeterminate until judgment processing (2) shown in FIG. 19 is executed. However, for the video portions in which reference points V_{cp1} and V_{cp3} were detected, it is assumed that there is both emotion matching and time matching. When judgment processing (4) shown in FIG. 20 is executed in this state, since there is time matching at reference points V_{cp1} and V_{cp3} in the vicinity, audience quality information of the judgment object in which reference point V_{cp2} was detected is judged as “present”. The same also applies to a case in which reference points V_{cp2} and V_{cp3} are detected as reference points in the vicinity of reference point V_{cp1}, and a case in which reference points V_{cp1} and V_{cp2} are detected as reference points in the vicinity of reference point V_{cp3}.

Thus, by means of integral judgment processing, integral judgment section 430 acquires video content audience quality information, generates audience quality data information, and stores this in audience quality data storage section 500 (step S1800 in FIG. 5). Specifically, for example, integral judgment section 430 edits expected emotion value information already stored in audience quality data storage section 500, and replaces the expected emotion value field with acquired audience quality information.

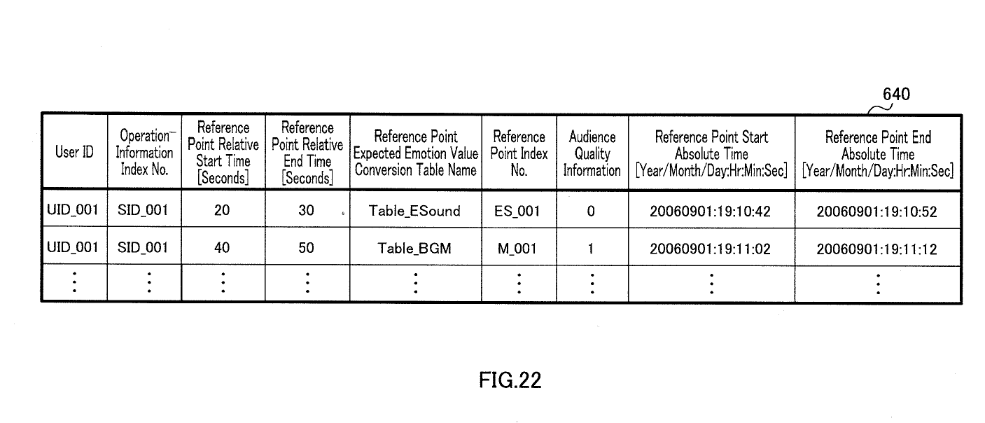

FIG. 22 is an explanatory drawing showing an example of audience quality data information generated by integral judgment section 430. As shown in FIG. 22, audience quality data information 640 has almost the same configuration as expected emotion value information 630 shown in FIG. 9. However, in audience quality data information 640, the expected emotion value field in expected emotion value information 630 is replaced with a audience quality information field, and audience quality information is stored. Here, a case is illustrated in which audience quality information “present” is indicated by a value of “1”, and audience quality information “absent” is indicated by a value of “0”. That is to say, analysis of audience quality data information 640 can show that a viewer did not view video content with interest for a video portion in which reference point index number “ES_{—}001” was present. Also, analysis of audience quality data information 640 can show that a viewer viewed video content with interest for a video portion in which reference point index number “M_{—}001” was present.

Audience quality information indicating the presence of a video portion for which a reference point was not detected may also be stored, and for a video portion for which there is either time matching or emotion matching but not both, audience quality information indicating “indeterminate” may be stored instead of performing judgment processing (1) or judgment processing (2).

Also, with what degree of interest a viewer viewed video content in its entirety may be determined by analyzing a plurality of items of audience quality information stored in audience quality data storage section 500, and this may be output as audience quality information. Specifically, for example, audience quality information “present” is converted to a value of “1” and audience quality information “absent” is converted to a value of “−1”, and the converted values are totaled for the entire video content. Furthermore, a numeric value corresponding to audience quality information may be changed according to the type of video content or the use of audience quality data information.

Also, by dividing the sum of values obtained when audience quality information “present” is converted to a value of “100” and audience quality information “absent” is converted to a value of “0” by the number of acquired items of audience quality information, the degree of interest of a viewer with respect to the entirety of video content can be expressed as a percentage. In this case, for example, if a unique value such as “50” is also assigned to audience quality information “indeterminate”, a audience quality information “indeterminate” state can be reflected in an evaluation value indicating with what degree of interest a viewer viewed video content.

As described above, according to this embodiment time matching and emotion matching are judged for expected emotion value information indicating an emotion expected to occur in a viewer when viewing video content and emotion information indicating an emotion that occurs in a viewer, and audience quality is judged from the result. By this means, it is possible to distinguish between what did and did not have an influence on the actual degree of interest in content from among emotion information, and to judge audience quality accurately. Also, judgment is performed by integrating time matching and emotion matching. This enables audience quality judgment to be performed that takes differences in individuals' reactions to video editing into consideration, for example. Furthermore, it is not necessary to impose restrictions on a viewer in order to suppress the influence of factors other than the degree of interest in content. This enables accurate audience quality judgment to be implemented without imposing any particular burden on a viewer. Moreover, expected emotion value information is acquired from the contents of video content video editing, allowing application to various kinds of video content.

In the audience quality data generation processing shown in FIG. 5, either the processing in steps S1000 and S1100 or the processing in steps S1200 through S1400 may be executed first, or both may be simultaneously executed in parallel. The same also applies to step S1500 and step S1600.

When there is either time matching or emotion matching but not both, it has been assumed that integral judgment section 430 judges time matching or emotion matching for a reference point in the vicinity of the judgment object, but this embodiment is not limited to this. For example, integral judgment section 430 may use time matching judgment information input from time matching judgment section 410 or emotion matching judgment information input from emotion matching judgment section 420 directly as a judgment result.

### Embodiment 2

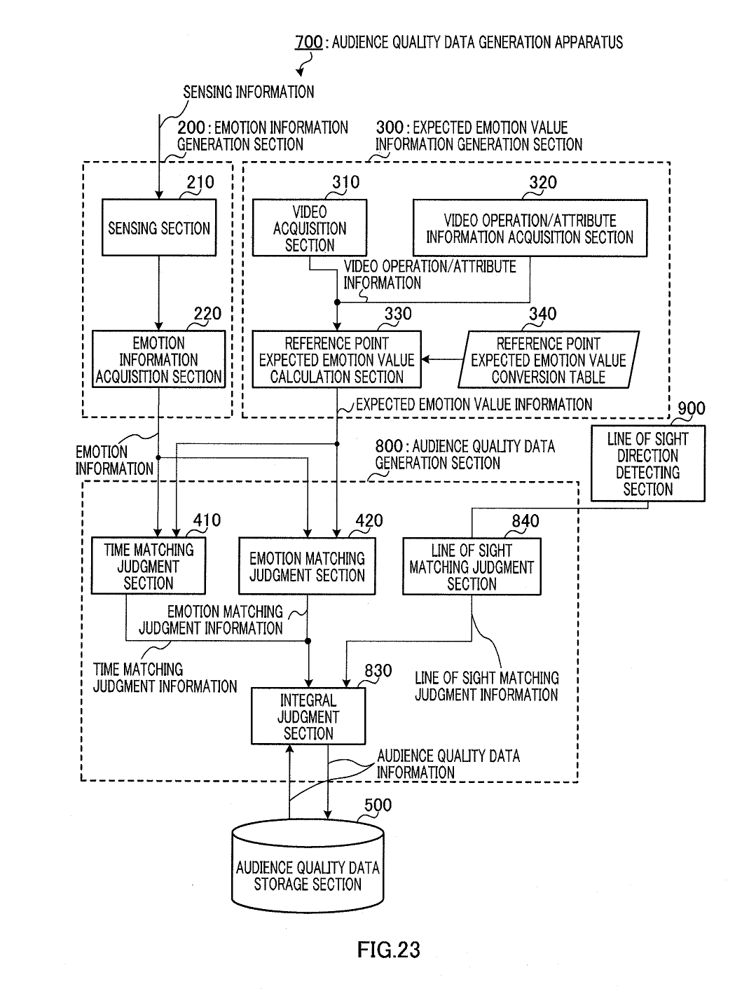

FIG. 23 is a block diagram showing the configuration of a audience quality data generation apparatus according to Embodiment 2 of the present invention, corresponding to FIG. 1 of Embodiment 1. Parts identical to those in FIG. 1 are assigned the same reference codes as in FIG. 1, and descriptions thereof are omitted.

Audience quality data generation apparatus 700 in FIG. 23 has line of sight direction detecting section 900 in addition to the configuration shown in FIG. 1. Also, audience quality data generation apparatus 700 has audience quality data generation section 800 equipped with integral judgment section 830, which executes different processing from integral judgment section 430 of Embodiment 1, and line of sight matching judgment section 840.

Line of sight direction detecting section 900 detects a line of sight direction of a viewer. Specifically, line of sight direction detecting section 900, for example, detects a line of sight direction of a viewer by analyzing the viewer's face direction and eyeball direction from an image captured by a digital camera that is placed in the vicinity of a screen on which video content is displayed and performs stereo imaging of the viewer from the screen side.

Line of sight matching judgment section 840 performs judgment of whether or not a detected viewer's line of sight direction (hereinafter referred to simply as “line of sight direction”) has line of sight matching toward a TV screen or suchlike video content display area, and generates line of sight matching judgment information indicating the judgment result. Specifically, line of sight matching judgment section 840 stores the position of a video content display area in advance, and determines whether or not the video content display area is present in the line of sight direction.

Integral judgment section 830 performs audience quality judgment by integrating time matching judgment information, emotion matching judgment information, and line of sight matching judgment information. Specifically, for example, integral judgment section 830 stores in advance a judgment table in which a audience quality information value is set for each combination of the above three judgment results, and performs audience quality information setting and acquisition by referencing this judgment table.

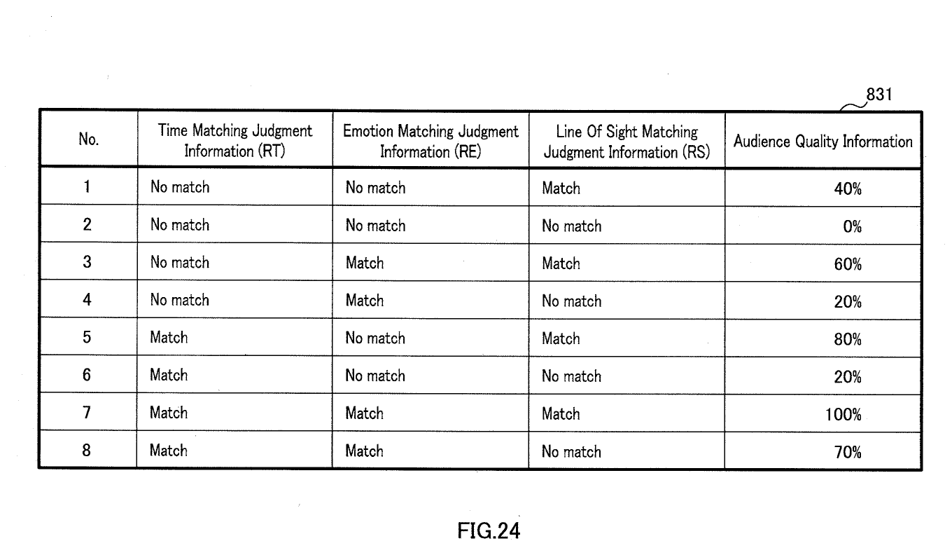

FIG. 24 is an explanatory drawing showing an example of the configuration of a judgment table used in integral judgment processing using a line of sight. There are entered in judgment table 831 audience quality information values associated with each combination of time matching judgment information (RT), emotion matching judgment information (RE), and line of sight matching judgment information (RS) judgment results. For example, audience quality information value “40%” is associated with a combination of time matching judgment information RT “No match”, emotion matching judgment information RE “No match”, and line of sight matching judgment result “Match”. This association indicates that, when there is no time matching or emotion matching but only line of sight matching, it is estimated that the viewer is viewing video content with a 40% degree of interest. A audience quality information value indicates a degree of interest with a value of 100% when there is time matching and emotion matching and line of sight matching, and a value of 0% when there is no time matching, no emotion matching, and no line of sight matching.

When time matching judgment information, emotion matching judgment information, and line of sight matching judgment information are input for a particular video portion, integral judgment section 830 searches for a matching combination in integral judgment section 830, acquires the corresponding audience quality information, and stores the acquired audience quality information in audience quality data storage section 500.

By performing audience quality judgment using this integral judgment section 830, integral judgment section 830 can acquire audience quality information speedily, and can implement precise judgment that takes line of sight matching into consideration.

With integral judgment section 830 shown in FIG. 24, a value of “20%” is associated with a case in which there is either time matching or emotion matching but no line of sight matching, but it is also possible to decide upon a more precise value by reflecting a judgment result of another reference point. Time match/emotion & line of sight mismatch judgment processing (hereinafter referred to as “judgment processing (5)”) and emotion match/time & line of sight mismatch judgment processing (hereinafter referred to as “judgment processing (6)”) will now be described. Here, judgment processing (5) is processing that performs audience quality judgment by performing more detailed analysis when there is time matching but there is no emotion matching, and judgment processing (6) is processing that performs audience quality judgment by performing more detailed analysis when there is emotion matching but there is no time matching.

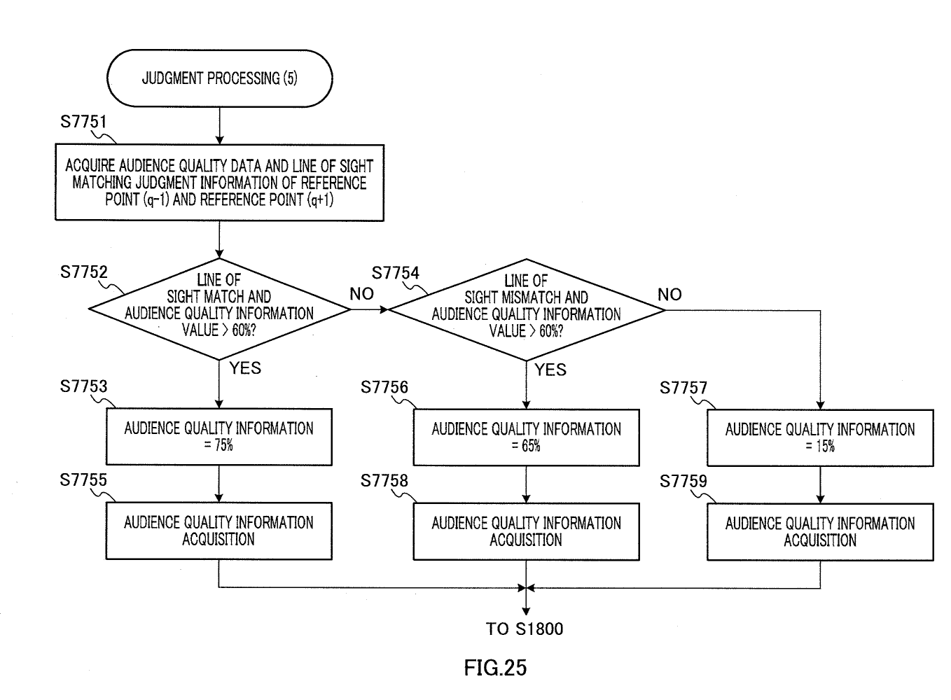

FIG. 25 is a flowchart showing an example of the flow of judgment processing (5). Below, the number of a judgment object reference point is indicated by parameter q. Also, in the following description, line of sight matching information and audience quality information values are assumed to have been acquired at reference points preceding and succeeding a judgment object reference point.

First, in step S7751, integral judgment section 830 acquires audience quality data and line of sight matching judgment information of reference point q−1 and reference point q+1—that is, reference points preceding and succeeding the judgment object.

Next, in step S7752, integral judgment section 830 determines whether or not the condition “there is line of sight matching and the audience quality information value exceeds 60% at both the preceding and succeeding reference points” is satisfied. Integral judgment section 830 proceeds to step S7753 if the above condition is satisfied (S7752: YES), or proceeds to step S7754 if the above condition is not satisfied (S7752: NO).

In step S7753, since the audience quality information value is comparatively high and the viewer is directing his line of sight toward video content at both the preceding and succeeding reference points, integral judgment section 830 judges that the viewer is viewing the video content with a comparatively high degree of interest, and sets a value of “75%” for audience quality information.

Then, in step S7755, integral judgment section 830 acquires the audience quality information for which it set a value, and proceeds to S1800 in FIG. 5 of Embodiment 1.

On the other hand, in step S7754, integral judgment section 830 determines whether or not the condition “there is no line of sight matching and the audience quality information value exceeds 60% at at least one of the preceding and succeeding reference points” is satisfied. Integral judgment section 830 proceeds to step S7756 if the above condition is satisfied (S7754: YES), or proceeds to step S7757 if the above condition is not satisfied (S7754: NO).

Instep S7756, since, although the viewer is not directing his line of sight toward video content at at least one of the preceding and succeeding reference points, the audience quality information value is comparatively high at both the preceding and succeeding reference points, integral judgment section 830 judges that the viewer is viewing the video content with a fairly high degree of interest, and sets a value of “65%” for audience quality information.

Then, in step S7758, integral judgment section 830 acquires the audience quality information for which it set a value, and proceeds to S1800 in FIG. 5 of Embodiment 1.

In step S7757, since the audience quality information value is comparatively low at at least one of the preceding and succeeding reference points, and the viewer is not directing his line of sight toward video content at at least one of the preceding and succeeding reference points, integral judgment section 830 judges that the viewer is viewing the video content with a rather low degree of interest, and sets a value of “15%” for audience quality information.

Then, in step S7759, integral judgment section 830 acquires the audience quality information for which it set a value, and proceeds to S1800 in FIG. 5 of Embodiment 1.

In this way, a audience quality information value can be decided upon with a good degree of precision by taking information acquired for preceding and succeeding reference points into consideration when there is time matching but there is no emotion matching.

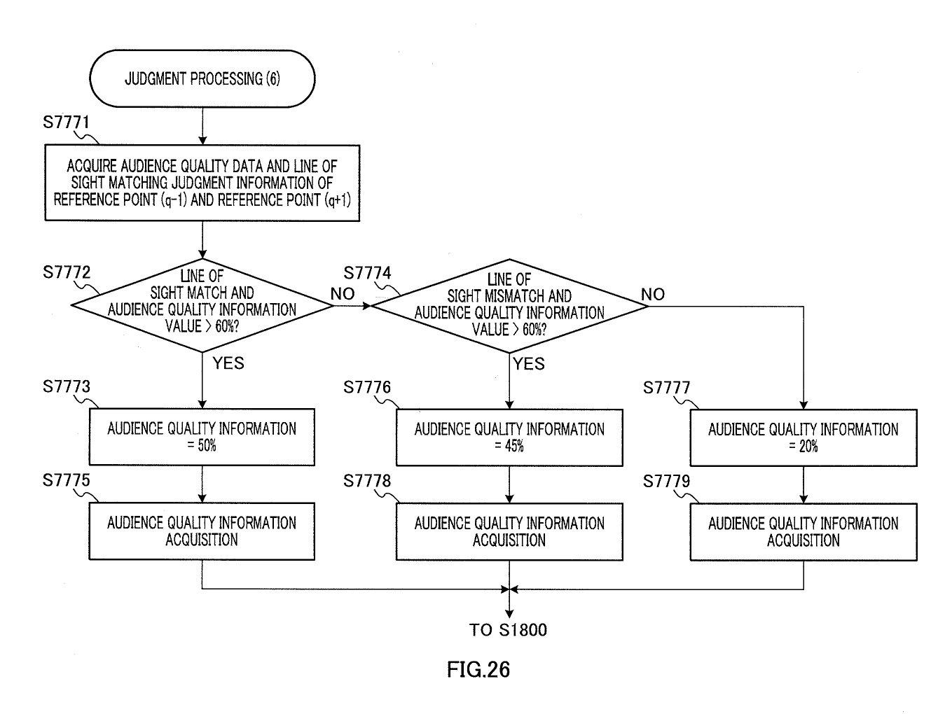

FIG. 26 is a flowchart showing an example of the flow of judgment processing (6).

First, in step S7771, integral judgment section 830 acquires audience quality data and line of sight matching judgment information of reference point q−1 and reference point q+1—that is, reference points preceding and succeeding the judgment object.

Next, in step S7772, integral judgment section 830 determines whether or not the condition “there is line of sight matching and the audience quality information value exceeds 60% at both the preceding and succeeding reference points” is satisfied. Integral judgment section 830 proceeds to step S7773 if the above condition is satisfied (S7772: YES), or proceeds to step S7774 if the above condition is not satisfied (S7772: NO).

In step S7773, since the audience quality information value is comparatively high and the viewer is directing his line of sight toward video content at both the preceding and succeeding reference points, integral judgment section 830 judges that the viewer is viewing the video content with a medium degree of interest, and sets a value of “50%” for audience quality information.

Then, in step S7775, integral judgment section 830 acquires the audience quality information for which it set a value, and proceeds to S1800 in FIG. 5 of Embodiment 1.

On the other hand, in step S7774, integral judgment section 830 determines whether or not the condition “there is no line of sight matching and the audience quality information value exceeds 60% at at least one of the preceding and succeeding reference points” is satisfied. Integral judgment section 830 proceeds to step S7776 if the above condition is satisfied (S7774: YES), or proceeds to step S7777 if the above condition is not satisfied (S7774: NO).

In step S7776, since, although the audience quality information value is comparatively high at both the preceding and succeeding reference points, the viewer is not directing his line of sight toward video content at at least one of the preceding and succeeding reference points, integral judgment section 830 judges that the viewer is viewing the video content with a fairly low degree of interest, and sets a value of “45%” for audience quality information.

Then, in step S7778, integral judgment section 830 acquires the audience quality information for which it set a value, and proceeds to S1800 in FIG. 5 of Embodiment 1.

In step S7777, since the audience quality information value is comparatively low at at least one of the preceding and succeeding reference points, and the viewer is not directing his line of sight toward video content at at least one of the preceding and succeeding reference points, integral judgment section 830 judges that the viewer is viewing the video content with a low degree of interest, and sets a value of “20%” for audience quality information.

Then, in step S7779, integral judgment section 830 acquires the audience quality information for which it set a value, and proceeds to S1800 in FIG. 5 of Embodiment 1.

In this way, a audience quality information value can be decided upon with a good degree of precision by taking information acquired for preceding and succeeding reference points into consideration when there is emotion matching but there is no time matching.

In FIG. 25 and FIG. 26, cases have been illustrated in which line of sight matching information and a audience quality information values can be acquired at preceding and succeeding reference points, but there may also be cases in which there is emotion matching but no time matching at a plurality of consecutive reference points, or at the first and last reference point. In such cases, provision may be made, for example, for only information of either a preceding or succeeding reference point to be used, or for information of either a preceding or succeeding consecutive plurality of reference points to be used.

In step S1800 in FIG. 5, a percentage value is entered in audience quality data information as audience quality information. Provision may also be made, for example, for integral judgment section 830 to calculate an average of audience quality information values acquired in the entirety of video content, and output a viewer's degree of interest in the entirety of video content as a percentage.

Thus, according to this embodiment, a line of sight matching judgment result is used in audience quality judgment in addition to an emotion matching judgment result and time matching judgment result. By this means, more accurate audience quality judgment and more precise audience quality judgment can be implemented. Also, the use of a judgment table enables judgment processing to be speeded up.

Provision may also be made for integral judgment section 830 first to attempt audience quality judgment by means of an emotion matching judgment result and time matching judgment result as a first stage, and to perform audience quality judgment using a line of sight matching judgment result as a second stage only if a judgment result cannot be obtained, such as when there is no reference point in a judgment object or there is no reference point in the vicinity.

In the above-described embodiments, a audience quality data generation apparatus has been assumed to acquire expected emotion value information from the contents of video content video editing, but the present invention is not limited to this. Provision may also be made, for example, for a audience quality data generation apparatus to add information indicating reference points and information indicating respective expected emotion values to video content in advance as metadata, and to acquire expected emotion value information from these items of information. Specifically, information indicating a reference point (including an Index Number, start time, and end time) and expected emotion value (a, b) may be entered as a set as metadata to be added for each reference point or scene.

A comment or evaluation by another viewer who views the same content may be published on the Internet or added to video content. Thus, if not many video editing points are included in video content and sufficient reference points cannot be detected, a audience quality data generation apparatus may supplement acquisition of expected emotion value information by analyzing such a comment or evaluation. Assume, for example, that the comment “The scene in which Mr. A appeared was particularly sad” is written in a blog published on the Internet. In this case, the audience quality data generation apparatus can detect a time at which “Mr. A” of the relevant content appears, acquire the detected time as a reference point, and acquire a value corresponding to “sad” as an expected emotion value.

As a method of judging emotion matching, the distance between an expected emotion value and a measured emotion value in an emotion model space has been compared with a threshold value, but the method is not limited to this. A audience quality data generation apparatus may also convert video editing contents of video content and viewer's biological information to respective emotion types, and judge whether or not the emotion types match or are similar. In this case, the audience quality data generation apparatus may take a time at which a specific emotion type such as “excited” occurs or a time period in which such an emotion type is occurring, rather than a point at which an emotion type transition occurs, as an object of emotion matching or time matching judgment.

Audience quality judgment of the present invention can, of course, be applied to various kinds of content other than video content, such as music content, Web text and suchlike text content, and so forth.

The disclosure of Japanese Patent Application No. 2007-040072, filed on Feb. 20, 2007, including the specification, drawings and abstract, is incorporated herein by reference in its entirety.

### INDUSTRIAL APPLICABILITY

A audience quality judging apparatus, audience quality judging method, audience quality judging program, and recording medium that stores this program according to the present invention are suitable for use as a audience quality judging apparatus, audience quality judging method, and audience quality judging program that enable audience quality to be judged accurately without imposing any particular burden on a viewer, and a recording medium that stores this program.

1. A audience quality judging apparatus comprising:
an expected emotion value information acquisition section that acquires expected emotion value information indicating an emotion expected to occur in a viewer who views content;
an emotion information acquisition section that acquires emotion information indicating an emotion that occurs in a viewer when viewing the content; and
a audience quality judgment section that judges audience quality of the content by comparing the emotion information with the expected emotion value information.

2. The audience quality judging apparatus according to claim 1, wherein the audience quality judgment section executes the comparison on respective time-divided portions of the content and judges the audience quality from a plurality of comparison results.

3. The audience quality judging apparatus according to claim 1, further comprising:
a content acquisition section that acquires the content; and
an expected emotion value information table in which a type of editing contents of the content and the expected emotion value information are associated in advance,
wherein the expected emotion value information acquisition section determines a type of editing contents of the acquired content and acquires the expected emotion value information by referencing the expected emotion value information table.

4. The audience quality judging apparatus according to claim 1, further comprising a sensing section that acquires biological information of the viewer,
wherein the emotion information acquisition section acquires the emotion information from the biological information.

5. The audience quality judging apparatus according to claim 1, wherein:
the expected emotion value information includes an expected emotion occurrence time indicating an occurrence time of the emotion expected to occur, and an expected emotion value indicating a type of the emotion expected to occur;
the emotion information includes an emotion occurrence time indicating an occurrence time of an emotion that occurs in the viewer, and a measured emotion value indicating a type of an emotion that occurs in the viewer; and
the audience quality judgment section comprises:
a time matching judgment section that judges presence or absence of time matching whereby the expected emotion occurrence time and the emotion occurrence time are synchronous;
an emotion matching judgment section that judges presence or absence of emotion matching whereby the expected emotion value and the measured emotion value are similar; and
an integral judgment section that judges the audience quality by integrating presence or absence of the time matching and presence or absence of the emotion matching.

6. The audience quality judging apparatus according to claim 5, wherein the integral judgment section judges that the viewer viewed with interest when the time matching and the emotion matching are both present, and judges that the viewer did not view with interest when the time matching and the emotion matching are both absent.

7. The audience quality judging apparatus according to claim 6, wherein the integral judgment section judges that whether or not the viewer viewed with interest is unknown when one of the time matching and emotion matching is present and the other is absent.

8. The audience quality judging apparatus according to claim 6, wherein:
the time matching judgment section judges presence or absence of the time matching per unit time for the content;
the emotion matching judgment section judges presence or absence of the emotion matching per unit time for the content; and
the integral judgment section determines the audience quality from judgment results of the time matching judgment section and the emotion matching judgment section.

9. The audience quality judging apparatus according to claim 8, wherein the integral judgment section, for a portion in which the time matching is present and the emotion matching is absent within the content, judges that the viewer viewed with interest when the time matching is present in another portion of the content, and judges that the viewer did not view with interest when the time matching is absent in the other portion.

10. The audience quality judging apparatus according to claim 8, wherein the integral judgment section, for a portion in which the time matching is absent and the emotion matching is present within the content, judges that the viewer viewed with interest when the emotion matching is present in another portion of the content, and judges that the viewer did not view with interest when the emotion matching is absent in the other portion.

11. The audience quality judging apparatus according to claim 5, wherein:
the content includes an image;
the audience quality judging apparatus further comprises:
a line of sight direction detecting section that detects a line of sight direction of the viewer; and
a line of sight matching judgment section that judges presence or absence of line of sight matching whereby the line of sight direction is toward an image included in the content; and
the integral judgment section judges the audience quality by integrating presence or absence of the time matching, presence or absence of the emotion matching, and presence or absence of the line of sight matching.

12. The audience quality judging apparatus according to claim 3, wherein:
the content is video content that includes at least one of music, a sound effect, a video shot, and camerawork;
the expected emotion value information table associates in advance the expected emotion value information with respective types for music, a sound effect, a video shot, and camerawork; and
the expected emotion value information acquisition section determines a type of an item included in the content among music, a sound effect, a video shot, and camerawork, and acquires the expected emotion value information by referencing the expected emotion value information table

13. The audience quality judging apparatus according to claim 5, wherein:
the expected emotion value information acquisition section acquires coordinate values of a space of an emotion model as the expected emotion value information;
the emotion information acquisition section acquires coordinate values of a space of the emotion model as the emotion information; and
the emotion matching judgment section judges presence or absence of the emotion matching from a distance between the expected emotion value and the measured emotion value in a space of the emotion model.

14. A audience quality judging method comprising:
an information acquiring step of acquiring expected emotion value information indicating an emotion expected to occur in a viewer who views content and emotion information indicating an emotion that occurs in a viewer when viewing the content;
an information comparing step of comparing the emotion information with the expected emotion value information; and
a audience quality judging step of judging audience quality of the content from a result of comparing the emotion information with the expected emotion value information.

15. A audience quality judging program that causes a computer to execute:
processing that acquires expected emotion value information indicating an emotion expected to occur in a viewer who views content and emotion information indicating an emotion that occurs in a viewer when viewing the content;
processing that compares the emotion information with the expected emotion value information; and
processing that judges audience quality of the content from a result of comparing the emotion information with the expected emotion value information.

16. A recording medium that stores a audience quality judging program that causes a computer to execute:
processing that acquires expected emotion value information indicating an emotion expected to occur in a viewer who views content and emotion information indicating an emotion that occurs in a viewer when viewing the content;
processing that compares the emotion information with the expected emotion value information; and
processing that judges audience quality of the content from a result of comparing the emotion information with the expected emotion value information.
